(19) United States
(12) Patent Application Publication
(10) Pub. No.: US 2023/0106412 A1
(43) Pub. Date: Apr. 6, 2023

(54) PATIENT SUPPORT APPARATUS WITH AUTOMATIC DISPLAY CONTROL

(71) Applicant: Stryker Corporation, Kalamazoo, MI (US)

(72) Inventors: Frank J. Lee, Kalamazoo, MI (US); Jason John Connell, London, Ontario (CA); Krishna Sandeep Bhimavarapu, Kalamazoo, MI (US); Kurosh Nahavandi, Portage, MI (US); Michael Joseph Hayes, Kalamazoo, MI (US)

(21) Appl. No.: 17/913,717

(22) PCT Filed: May 20, 2021
(86) PCT No.: PCT/US2021/033407

§ 371 Date: Sep. 22, 2022

Related U.S. Application Data
(60) Provisional application No. 63/031,973, filed on May 29, 2020.

(51) Int. Cl. A61G 7/05; G09G 3/18; G06N 20/00

(52) U.S. Cl. CPC A61G 7/0524; G09G 3/18; G06N 20/00; A61G 2203/20; A61G 2203/30; G09G 2320/0626; G09G 2320/08; G09G 2360/144

(57) ABSTRACT

A patient support apparatus, such as a bed, cot, stretcher, recliner, or the like, includes a patient support surface, a display, a plurality of indicators and/or controls, an ambient light sensors, and a controller. The display is adapted to be illuminated at multiple illumination levels, and the controller is adapted to receive ambient light level readings from the ambient light sensor, to use the ambient light level readings to automatically select a particular brightness level for the display, and to cause the display to display information at the particular brightness level. In some embodiments, multiple ambient light sensors are included and the readings of those within a valid range are averaged together to determine the particular brightness level. Machine learning algorithms may also be included for selecting the brightness level based on a user's prior history of manually selecting a brightness level.

### BACKGROUND

The present disclosure relates to patient support apparatuses, such as beds, cots, stretchers, recliners, or the like. More specifically, the present disclosure relates to patient support apparatuses that include one or more illuminated components, such as displays, lights, and/or other illuminated indicators.

Conventional patient support apparatuses comprise a base, a litter frame, a support deck upon which the patient is supported, a lift system for lifting and lowering the litter frame relative to the base, and an articulation system for articulating one or more sections of the support deck. Control of these and other systems of the patient support apparatus is performed via one or more control panels positioned on the patient support apparatus, such as on a footboard or on one or more of the siderails of the patient support apparatus. The control panel typically includes a display, such as a Liquid Crystal Display (LCD), or the like, that displays information for using the patient support apparatus. In addition, one or more alert lights and/or illuminated controls and/or illuminated indicators may be provided on the patient support apparatus.

### SUMMARY

According to various embodiments, an improved patient support apparatus is provided that is configured to automatically adjust the brightness level of one or more of the illuminated components of the patient support apparatus, such as, but not limited to, the display, the alert light(s), the control(s), and/or the indicator(s). The automatic brightness control of these various illuminated components may be carried out in unison so that all of the illuminated components are illuminated at the same varying illumination level, or one or more of the illuminated components may have its brightness automatically adjusted to a level that is different from one or more of the other illuminated components. In some embodiments, some of the illuminated components may have a static brightness level while at least one of the illuminated components has its brightness level automatically adjusted. The brightness adjustments, in some embodiments, automatically take into account the ambient light levels so that the brightness levels are sufficient for easy viewing, but not so bright as to create visual disturbances, either to patients positioned on the patient support apparatuses or people positioned within the vicinity of the patient support apparatuses.

According to one embodiment of the present disclosure, a patient support apparatus is provided that includes a frame, a support surface, a display, a plurality of ambient light sensors, and a controller. The support surface is supported by the frame and is adapted to support a patient thereon. The display is adapted to display information at multiple brightness levels. The plurality of ambient light sensors are adapted to detect ambient light levels adjacent the display. The controller is adapted to perform the following: to receive ambient light level readings from each of the plurality of ambient light sensors, to determine if the ambient light level readings are within a predetermined range, to determine an average light level reading by averaging together only those ambient light level readings that are within the predetermined range, to use the average light level reading to automatically select a particular brightness level for the display, and to cause the display to display information at the particular brightness level.

According to other aspects of the present disclosure, the patient support apparatus further comprises a plurality of indicators spaced away from the display and configured to be illuminated at multiple brightness values. In such embodiments, the controller may be further adapted to automatically use the average light level reading to automatically select a particular brightness value for illuminating the plurality of indicators. In some embodiments, the plurality of indicators are included within a dashboard positioned underneath the display.

In some embodiments, the patient support apparatus further comprises a plurality of controls spaced away from the display and configured to be illuminated at multiple brightness values. In such embodiments, the controller may be further adapted to automatically use the average light level reading to automatically select a particular brightness value for illuminating the plurality of controls. In such embodiments, a first subset of the plurality of controls may be positioned adjacent a right side of the display and a second subset of the plurality of controls may be positioned adjacent a left side of the display.

In some embodiments, the controller is further adapted to apply a low pass filter to the ambient light level readings prior to determining if the ambient light level readings are within a predetermined range. The low pass filter is adapted filter out transient changes in the ambient light level readings.

The controller, in some embodiments of the patient support apparatus, is further adapted to apply a compensation factor to the average light level reading and to use the compensated average light level reading to select the particular brightness level for the display. In such embodiments, the compensation factor is adapted to compensate for ultraviolet and infrared components of the ambient light level readings.

In some embodiments, the controller is further adapted to implement a delay period before automatically causing the display to display the information at the particular brightness level if the particular brightness level differs from a previously selected brightness level by more than a threshold. The delay period may be on the order of three to five seconds.

In some embodiments, the patient support apparatus further comprises a set of controls spaced away from the display and a separate ambient light sensor. The set of controls are configured to be illuminated at multiple brightness levels and the separate ambient light sensor is associated with the set of controls. The separate ambient light sensor is adapted to generate a separate ambient light level reading indicative of a level of ambient illumination adjacent the set of controls. In such embodiments, the controller is further adapted to automatically select a specific brightness level for the set of controls based on the separate ambient light level reading and to cause the set of controls to be illuminated at the specific brightness level. The specific brightness level is independent of the particular brightness level.

In some embodiments, the controller is further configured to override the particular brightness level in response to a triggering condition, wherein the controller automatically illuminates the display at a preset brightness level in response to the triggering condition. The triggering condition, in some embodiments, is movement of the patient support apparatus from one location to another location, and the preset brightness level is a maximum brightness level. In other embodiments, the triggering condition may alternatively, or additionally, include a particular time of day.

In some embodiments, the patient support apparatus further comprises a manual brightness control adapted to be activated and deactivated by a user. In such embodiments, the controller is further adapted to cause the display to display the information at a user-defined brightness level when the manual brightness control is activated and to display the information at the particular brightness level when the manual brightness control is not activated.

The controller, in some embodiments, is further adapted to store in a memory the user-defined brightness levels and a plurality of concomitant ambient light level readings taken when the manual brightness control has been activated. In such embodiments, the controller is further adapted to use the stored plurality of concomitant ambient light level readings and the stored user-defined brightness levels in a machine learning algorithm.

The controller, in some embodiments, is further configured to use the machine learning algorithm to define a future particular brightness level for the display for future use when the user has not activated the manual brightness control. The machine learning algorithm may be a linear regression algorithm, although other types of machine learning algorithms may also or alternatively be used.

In some embodiments, the patient support apparatus further comprises an alert light adapted to be illuminated when an alert condition is detected by the controller. In such embodiments, the controller may be further adapted to use the average light level reading to select an alert level brightness level and to cause the alert light to be illuminated at the selected alert level brightness level if an alert condition is detected.

According to another aspect of the present disclosure, a patient support apparatus is provided that includes a frame, a support surface, a display, an ambient light sensor, and a controller. The support surface is supported by the frame and is adapted to support a patient thereon. The display is adapted to display information at multiple brightness levels. The ambient light sensor is adapted to detect ambient light levels adjacent the display. The controller is adapted to receive ambient light level readings from the ambient light sensor and to use the ambient light level readings to automatically select a particular brightness level for the display and to cause the display to display the information at the particular brightness level.

According to other aspects of the present disclosure, the patient support apparatus may further include a set of controls and a second ambient light sensor. The set of controls are spaced away from the display and configured to be illuminated at multiple brightness levels. The second ambient light sensor is associated with the set of controls and is adapted to generate a separate ambient light level reading indicative of a level of ambient illumination adjacent the set of controls. The controller is further adapted to automatically select a specific brightness level for the set of controls based on the separate ambient light level reading and to cause the set of controls to be illuminated at the specific brightness level. The specific brightness level is independent of the particular brightness level.

In some embodiments, the controller is further configured to override the particular brightness level in response to a triggering condition. In such embodiments, the controller automatically illuminates the display at a preset brightness level in response to the triggering condition. The triggering condition may be movement of the patient support apparatus from one location to another location and/or a particular time of day, and the preset brightness level may be a maximum brightness level and/or a minimum brightness level.

In some embodiments, the patient support apparatus further comprises a manual brightness control adapted to be activated and deactivated by a user. In such embodiments, the controller is further adapted to cause the display to display the information at a user-defined brightness level when the manual brightness control is activated and to display the information at the particular brightness level when the manual brightness control is not activated.

The controller may further be adapted to store in a memory the user-defined brightness levels and a plurality of concomitant ambient light level readings taken when the manual brightness control has been activated. In such embodiments, the controller is further adapted to use the stored plurality of concomitant ambient light level readings and the stored user-defined brightness levels in a machine learning algorithm. The machine learning algorithm is configured to define a future particular brightness level for the display for future use when the user has not activated the manual brightness control.

In some embodiments, the patient support apparatus further comprises an alert light adapted to be illuminated when an alert condition is detected by the controller, wherein the controller is further adapted to use the ambient light level readings to select an alert level brightness level and to cause the alert light to be illuminated at the selected alert level brightness level if an alert condition is detected.

In some embodiments, the patient support apparatus further comprises a plurality of indicators spaced away from the display and configured to be illuminated at multiple brightness values. In such embodiments, the controller is further adapted to automatically use the ambient light level readings to automatically select a particular brightness value for illuminating the plurality of indicators.

In some embodiments, the patient support apparatus further comprises a plurality of controls spaced away from the display and configured to be illuminated at multiple brightness values. In such embodiments, the controller is further adapted to automatically use the ambient light level readings to automatically select a particular brightness value for illuminating the plurality of controls.

The controller may be adapted to apply a low pass filter to the ambient light level readings prior to selecting the particular brightness level for the display, wherein the low pass filter is adapted filter out transient changes in the ambient light level readings. The controller may be further adapted to apply a compensation factor to the ambient light level readings and to use the compensated ambient light level readings to selected the particular brightness level for the display. The compensation factor is adapted to compensate for ultraviolet and infrared components of the ambient light level readings.

A patient support apparatus according to another embodiment of the present disclosure includes a frame, a support surface, a display, an ambient light sensor, a manual brightness control, and a controller. The support surface is supported by the frame and adapted to support a patient thereon. The display is adapted to display information at multiple brightness levels. The ambient light sensor is adapted to detect ambient light levels adjacent the display. The manual brightness control is adapted to be activated and deactivated by a user. When activated, the manual brightness control causes the display to display the information at a user-defined brightness level. The controller is adapted to receive ambient light level readings from the ambient light sensor and to perform the following: (a) when the manual brightness control is not activated, to use the ambient light level readings to automatically select a particular brightness level for the display and to cause the display to display information at the particular brightness level; and (b) when the manual brightness control is activated, to store in a memory a plurality of the user-defined brightness levels and a plurality of concomitant ambient light level readings, and to use the stored plurality of concomitant ambient light level readings and the stored user-defined brightness levels in a machine learning algorithm. The machine learning algorithm is adapted to define a future particular brightness level for the display for future use when the user has not activated the brightness control.

According to other aspects of the present disclosure, the patient support apparatus further comprises a plurality of indicators spaced away from the display and configured to be illuminated at multiple brightness values. In such embodiments, the controller is further adapted to automatically perform the following: (a) when the manual brightness control is not activated, to use the ambient light level readings to automatically select a brightness value for illuminating the plurality of indicators; and (b) when the manual brightness control is activated, to use the user-defined brightness level to illuminate the plurality of indicators. The selected brightness value may be different from the particular brightness level.

In some embodiments, the patient support apparatus further comprises a plurality of controls spaced away from the display and configured to be illuminated at multiple brightness values. In such embodiments, the controller is further adapted to perform the following: (a) when the manual brightness control is not activated, to use the ambient light level readings to automatically select a brightness value for illuminating the plurality of controls; and (b) when the manual brightness control is activated, to use the user-defined brightness level to illuminate the plurality of controls.

The controller, in some embodiments, may be further adapted to apply a low pass filter to the ambient light level readings prior to selecting the particular brightness level for the display. The low pass filter is adapted filter out transient changes in the ambient light level readings.

The controller may also, or alternatively, be adapted to apply a compensation factor to the ambient light level readings and to use the compensated ambient light level readings to selected the particular brightness level for the display. The compensation factor is adapted to compensate for ultraviolet and infrared components of the ambient light level readings.

In some embodiments, the machine learning algorithm is a linear regression algorithm.

In some embodiments, the controller is further adapted to implement a delay period before causing the display to display the information at the particular brightness level if the particular brightness level differs from a previously selected brightness level by more than a threshold.

In some embodiments, the patient support apparatus further comprises a set of controls spaced away from the display and configured to be illuminated at multiple brightness levels, as well as a second ambient light sensor associated with the set of controls. The second ambient light sensor is adapted to generate a separate ambient light level reading indicative of a level of ambient illumination adjacent the set of controls. In such embodiments, the controller is further adapted to perform the following: (a) when the manual brightness control is not activated, to use the separate ambient light level readings to automatically select a brightness value for illuminating the set of controls; and (b) when the manual brightness control is activated, to use the user-defined brightness level to illuminate the set of controls.

In some embodiments, the controller is further configured to override the particular brightness level in response to a triggering condition. In such embodiments, the controller automatically illuminates the display at a preset brightness level in response to the triggering condition. The triggering condition may be movement of the patient support apparatus from one location to another location and/or a particular time of day, and the preset brightness level may be a maximum brightness level and/or a minimum brightness level.

In some embodiments, the patient support apparatus further comprises a second light sensor adapted to detect second ambient light levels adjacent the display. In such embodiments, the controller may be further adapted to determine if the ambient light level readings and the second ambient light levels are within a predetermined range, to determine an average light level reading by averaging together only those of the ambient light level readings and the second ambient light level readings that are within the predetermined range, and to use the average light level reading to select the particular brightness level for the display when the manual brightness control is not activated.

Before the various embodiments disclosed herein are explained in detail, it is to be understood that the claims are not to be limited to the details of operation, to the details of construction, or to the arrangement of the components set forth in the following description or illustrated in the drawings. The embodiments described herein are capable of being practiced or being carried out in alternative ways not expressly disclosed herein. In addition, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the claims to any specific order or number of components. Nor should the use of enumeration be construed as excluding from the scope of the claims any additional steps or components that might be combined with or into the enumerated steps or components.

### BRIEF DESCRIPTION OF THE DRAWINGS

FIG. 1 is a perspective view of a patient support apparatus having a plurality of control panels;

FIG. 2 is a plan view of a first one of the control panels of FIG. 1;

FIG. 3 is an exploded perspective view of the control panel of FIG. 2;

FIG. 4 is a plan view of a second one of the control panels of FIG. 1;

FIG. 5 is a schematic diagram of a control system of the patient support apparatus and its environment, including the first and second control panels and other components;

FIG. 6 is a flow diagram of a first brightness control algorithm that may be used by the patient support apparatus of FIG. 1;

FIG. 7 is a flow diagram of a second brightness control algorithm that may be used by the patient support apparatus of FIG. 1; and

FIG. 8 is a graph of a machine learning algorithm that may be used by the patient support apparatus of FIG. 1 and/or one or more offboard servers.

### DETAILED DESCRIPTION OF THE EMBODIMENTS

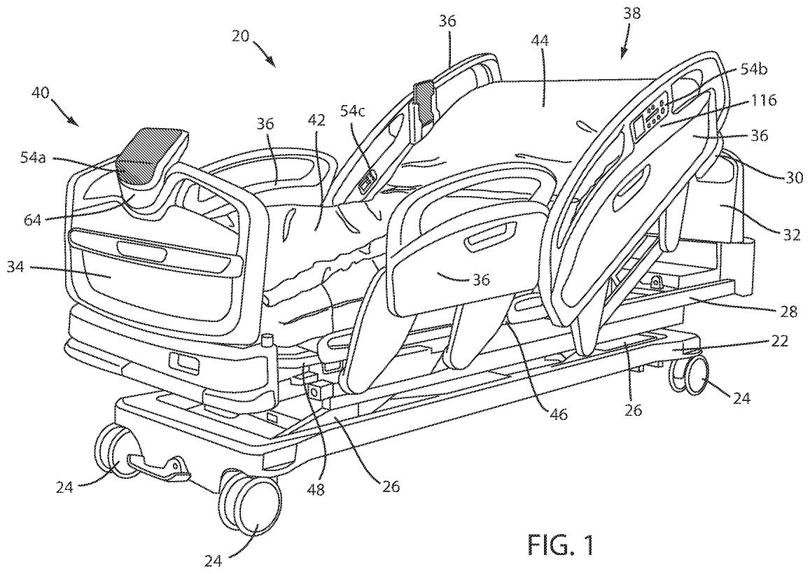

An illustrative patient support apparatus 20 according to a first embodiment of the present disclosure is shown in FIG. 1. Although the particular form of patient support apparatus 20 illustrated in FIG. 1 is a bed adapted for use in a hospital or other medical setting, it will be understood that patient support apparatus 20 could, in different embodiments, be a cot, a stretcher, a recliner, or any other structure capable of supporting a patient in a healthcare environment.

In general, patient support apparatus 20 includes a base 22 having a plurality of wheels 24, a pair of lifts 26 supported on the base 22, a litter frame 28 supported on the lifts 26, and a support deck 30 supported on the litter frame 28. Patient support apparatus 20 further includes a headboard 32, a footboard 34 and a plurality of siderails 36. Siderails 36 are all shown in a raised position in FIG. 1 but are each individually movable to a lower position in which ingress into, and egress out of, patient support apparatus 20 is not obstructed by the lowered siderails 36.

Lifts 26 are adapted to raise and lower litter frame 28 with respect to base 22. Lifts 26 may be hydraulic actuators, electric actuators, or any other suitable device for raising and lowering litter frame 28 with respect to base 22. In the illustrated embodiment, lifts 26 are operable independently so that the tilting of litter frame 28 with respect to base 22 can also be adjusted, to place the litter frame 28 in a flat or horizontal orientation, a Trendelenburg orientation, or a reverse Trendelenburg orientation. That is, litter frame 28 includes a head end 38 and a foot end 40, each of whose height can be independently adjusted by the nearest lift 26. Patient support apparatus 20 is designed so that when an occupant lies thereon, his or her head will be positioned adjacent head end 38 and his or her feet will be positioned adjacent foot end 40. The lifts 26 may be constructed and/or operated in any of the manners disclosed in commonly assigned U.S. patent publication 2017/0246065, filed on Feb. 22, 2017, entitled LIFT ASSEMBLY FOR PATIENT SUPPORT APPARATUS, the complete disclosure of which is hereby incorporated herein by reference. Other manners for constructing and/or operating lifts 26 may, of course, be used.

Litter frame 28 provides a structure for supporting support deck 30, the headboard 32, footboard 34, and siderails 36. Support deck 30 provides a support surface for a mattress 42, or other soft cushion, so that a person may lie and/or sit thereon. The top surface of the mattress 42 or other cushion forms a support surface for the occupant.

Support deck 30 is made of a plurality of sections, some of which are pivotable about generally horizontal pivot axes. In the embodiment shown in FIG. 1, support deck 30 includes at least a head section 44, a thigh section 46, and a foot section 48, all of which are positioned underneath mattress 42 and which generally form flat surfaces for supporting mattress 42. Head section 44, which is also sometimes referred to as a Fowler section, is pivotable about a generally horizontal pivot axis between a generally horizontal orientation (not shown in FIG. 1) and a plurality of raised positions (one of which is shown in FIG. 1). Thigh section 46 and foot section 48 may also be pivotable about generally horizontal pivot axes.

In some embodiments, patient support apparatus 20 may be modified from what is shown to include one or more components adapted to allow the user to extend the width of patient support deck 30, thereby allowing patient support apparatus 20 to accommodate patients of varying sizes. When so modified, the width of deck 30 may be adjusted sideways in any increments, for example between a first or minimum width, a second or intermediate width, and a third or expanded/maximum width.

As used herein, the term “longitudinal” refers to a direction parallel to an axis between the head end 38 and the foot end 40. The terms “transverse” or “lateral” refer to a direction perpendicular to the longitudinal direction and parallel to a surface on which the patient support apparatus 20 rests.

It will be understood by those skilled in the art that patient support apparatus 20 can be designed with other types of mechanical constructions, such as, but not limited to, that described in commonly assigned, U.S. Pat. No. 10,130,536 to Roussy et al., entitled PATIENT SUPPORT USABLE WITH BARIATRIC PATIENTS, the complete disclosure of which is incorporated herein by reference. In another embodiment, the mechanical construction of patient support apparatus 20 may be the same as, or nearly the same as, the mechanical construction of the Model 3002 S3 bed manufactured and sold by Stryker Corporation of Kalamazoo, Mich. This mechanical construction is described in greater detail in the Stryker Maintenance Manual for the MedSurg Bed, Model 3002 S3, published in 2010 by Stryker Corporation of Kalamazoo, Mich., the complete disclosure of which is incorporated herein by reference. It will be understood by those skilled in the art that patient support apparatus 20 can be designed with still other types of mechanical constructions, such as, but not limited to, those described in commonly assigned, U.S. Pat. No. 7,690,059 issued to Lemire et al., and entitled HOSPITAL BED; and/or commonly assigned U.S. 2007/0163045 filed by Becker et al. and entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosures of both of which are also hereby incorporated herein by reference. The mechanical construction of patient support apparatus 20 may also take on still other forms different from what is disclosed in the aforementioned references.

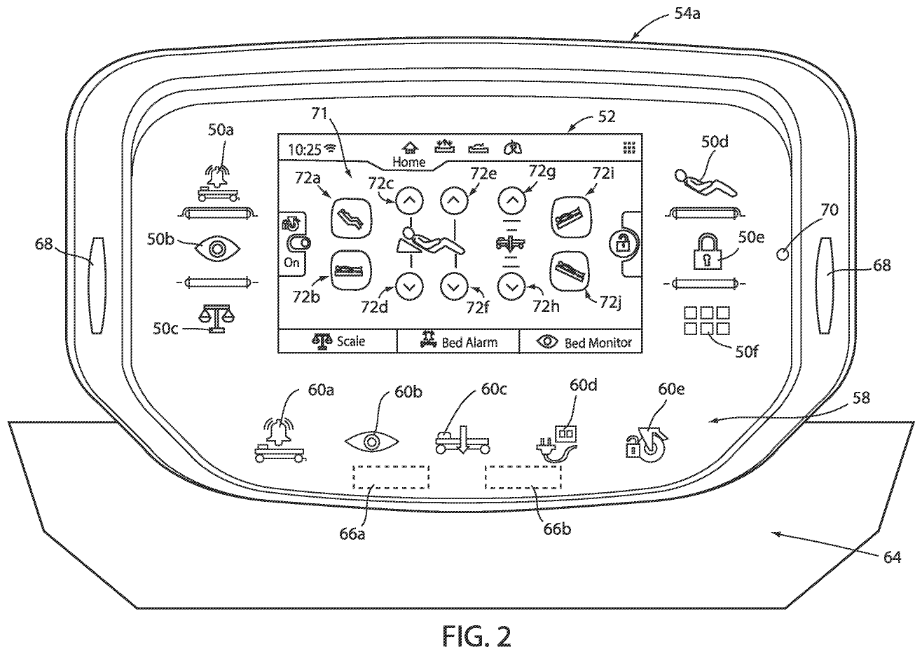

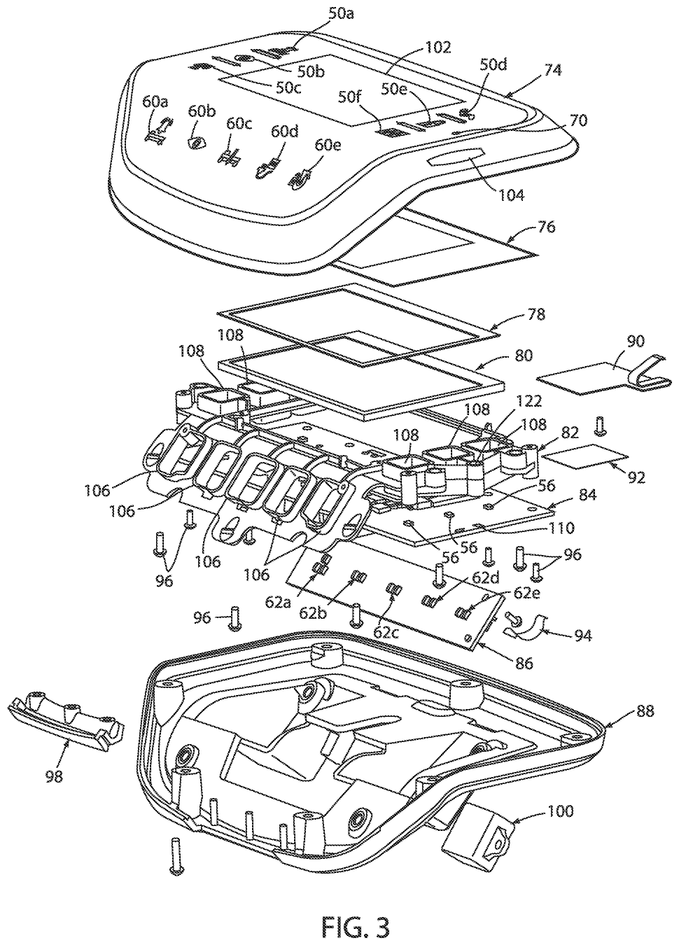

Patient support apparatus 20 further includes a plurality of control panels 54 that enable a user of patient support apparatus 20, such as a patient and/or an associated caregiver, to control one or more aspects of patient support apparatus 20. In the embodiment shown in FIG. 1, patient support apparatus 20 includes a footboard control panel 54a, a pair of outer siderail control panels 54b (only one of which is visible), and a pair of inner siderail control panels 54c (only one of which is visible). Footboard control panel 54a and outer siderail control panels 54b are intended to be used by caregivers, or other authorized personnel, while inner siderail control panels 54c are intended to be used by the patient associated with patient support apparatus 20. Each of the control panels 54 includes a plurality of controls 50 (see, e.g. FIGS. 2-3), although each control panel 54 does not necessarily include the same controls and/or functionality.

Among other functions, controls 50 of control panel 54a allow a user to control one or more of the following: change a height of support deck 30, raise or lower head section 44, activate and deactivate a brake for wheels 24, arm and disarm an exit detection system, and communicate with the particular IT infrastructure installed in the healthcare facility in which patient support apparatus 20 is positioned. One or both of the inner siderail control panels 54c also include at least one control that enables a patient to call a remotely located nurse (or other caregiver). In addition to the nurse call control, one or both of the inner siderail control panels 54c may also include one or more controls for controlling one or more features of a television, room light, and/or reading light positioned within the same room as the patient support apparatus 20. With respect to the television, the features that may be controllable by one or more controls 50 on control panel 54c include, but are not limited to, the volume, the channel, the closed-captioning, and/or the power state of the television. With respect to the room and/or night lights, the features that may be controlled by one or more controls 50 on control panel 54c include the on/off state of these lights.

Control panel 54a includes a display 52 (FIG. 2) configured to display a plurality of different screens thereon. Display 52 may be a touchscreen-type display, although it will be understood that a non-touchscreen display may alternatively be used. Display 52 displays one or more visual indicators, one or more controls, and/or one or more control screens, and/or other types of information, as will be discussed more below. Display 52 may comprise an LED display, an OLED display, or another type of display. Display 52 is configured to have its brightness level adjusted. That is, the amount of light emitted from display 52 can be varied by a controller included within patient support apparatus 20, as will be discussed in greater detail below.

Surrounding display 52 are a plurality of navigation controls 50a-f that, when activated, cause the display 52 to display different screens on display 52. More specifically, when a user presses navigation control 50a, control panel 54a displays an exit detection control screen on display 52 that includes one or more icons that, when touched, control an onboard exit detection system. The exit detection system is as adapted to issue an alert when a patient exit from patient support apparatus 20. Such an exit detection system may include any of the features and functions as, and/or may be constructed in any of the same manners as, the exit detection system disclosed in commonly assigned U.S. patent application 62/889,254 filed Aug. 20, 2019, by inventors Sujay Sukumaran et al. and entitled PERSON SUPPORT APPARATUS WITH ADJUSTABLE EXIT DETECTION ZONES, the complete disclosure of which is incorporated herein by reference. Other types of exit detection systems can also or alternatively be used.

When a user pressed navigation control 50b (FIG. 2), control panel 54 displays a monitoring control screen that includes a plurality of control icons that, when touched, control an onboard monitoring system built into patient support apparatus 20. Further details of one type of monitoring system that may be built into patient support apparatus 20 are disclosed in commonly assigned U.S. patent application Ser. No. 62/864,638 filed Jun. 21, 2019, by inventors Kurosh Nahavandi et al. and entitled PATIENT SUPPORT APPARATUS WITH CAREGIVER REMINDERS, as well as commonly assigned U.S. patent application Ser. No. 16/721,133 filed Dec. 19, 2019, by inventors Kurosh Nahavandi et al. and entitled PATIENT SUPPORT APPARATUSES WITH MOTION CUSTOMIZATION, the complete disclosures of both of which are incorporated herein by reference. Other types of monitoring systems can also or alternatively be included with patient support apparatus 20.

When a user presses navigation control 50c, control panel 54a displays a scale control screen that includes a plurality of control icons that, when touched, control the scale system of patient support apparatus 20. Such a scale system may include any of the features and functions as, and/or may be constructed in any of the same manners as, the scale systems disclosed in commonly assigned U.S. patent application 62/889,254 filed Aug. 20, 2019, by inventors Sujay Sukumaran et al. and entitled PERSON SUPPORT APPARATUS WITH ADJUSTABLE EXIT DETECTION ZONES, and U.S. patent application Ser. No. 62/885,954 filed Aug. 13, 2019, by inventors Kurosh Nahavandi et al. and entitled PATIENT SUPPORT APPARATUS WITH EQUIPMENT WEIGHT LOG, the complete disclosures of both of which are incorporated herein by reference. Other types of scale systems can also or alternatively be included with patient support apparatus 20.

When a user presses navigation control 50d, control panel 54 displays a motion control screen that includes a plurality of control icons that, when touched, control the movement of various components of patient support apparatus 20, such as, but not limited to, the height of litter frame 28 and the pivoting of head section 44. In some embodiments, the motion control screen displayed on display 52 in response to pressing control 50d may be the same as, or similar to, the position control screen 216 disclosed in commonly assigned U.S. patent application Ser. No. 62/885,953 filed Aug. 13, 2019, by inventors Kurosh Nahavandi et al. and entitled PATIENT SUPPORT APPARATUS WITH TOUCHSCREEN, the complete disclosure of which is incorporated herein by reference. In some embodiments, the motion control screen takes on the form of motion control screen 71 shown in FIG. 2. Other types of motion control screens can also or alternatively be included with patient support apparatus 20.

When a user presses navigation control 50e, control panel 54a displays a motion lock control screen that includes a plurality of control icons that, when touched, control one or more motion lockout functions of patient support apparatus 20. Such a motion lockout screen may include any of the features and functions as, and/or may be constructed in any of the same manners as, the motion lockout features, functions, and constructions disclosed in commonly assigned U.S. patent application Ser. No. 16/721,133 filed Dec. 19, 2019, by inventors Kurosh Nahavandi et al. and entitled PATIENT SUPPORT APPARATUSES WITH MOTION CUSTOMIZATION, the complete disclosures of both of which are incorporated herein by reference. Other types of motion lockout control screens can also or alternatively be included with patient support apparatus 20.

When a user presses on navigation control 50f, control panel 54a displays a menu screen that includes a plurality of menu icons that, when touched, bring up one or more additional screens for controlling and/or viewing one or more other aspects of patient support apparatus 20. Such other aspects include, but are not limited to, diagnostic and/or service information for patient support apparatus 20, mattress control and/or status information, configuration settings, and other settings and/or information. One example of a suitable menu screen is the menu screen 100 disclosed in commonly assigned U.S. patent application Ser. No. 62/885,953 filed Aug. 13, 2019, by inventors Kurosh Nahavandi et al. and entitled PATIENT SUPPORT APPARATUS WITH TOUCHSCREEN, the complete disclosure of which is incorporated herein by reference. Other types of menu screens can also or alternatively be included with patient support apparatus 20.

For all of the navigation controls 50a-f (FIG. 2), screens other than the ones specifically mentioned above may be displayed on display 52 in other embodiments of patient support apparatus 20 in response to a user pressing these controls. Thus, it will be understood that the specific screens mentioned above are merely representative of the types of screens that are displayable on display 52 in response to a user pressing on one or more of navigation controls 50a-f. It will also be understood that, although navigation controls 50a-f have all been illustrated in the accompanying drawings as dedicated controls that are positioned adjacent display 52, any one or more of these controls 50a-f could alternatively be touchscreen controls that are displayed at one or more locations on display 52. Still further, although controls 50a-f have been shown herein as buttons, it will be understood that any of controls 50a-f could also, or alternatively, be switches, dials, or other types of non-button controls.

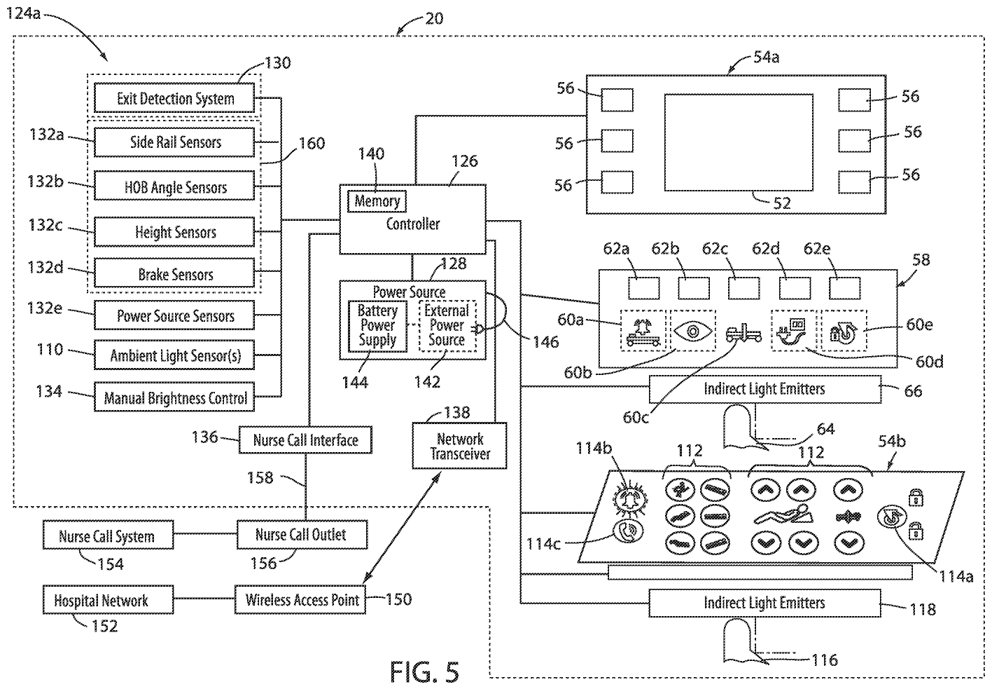

Control panel 54a, in some embodiments, also includes a dashboard 58 (FIG. 2) that communicates the current states of various conditions of patient support apparatus 20 to a caregiver. Dashboard 58 comprises a plurality of icons 60 that are individually illuminated via icon lights 62 (FIG. 5) to thereby act as visual indicators for indicating the current state of different conditions of patient support apparatus 20. For example, as shown more clearly with respect to FIGS. 2 and 5, a first icon 60a (e.g., a graphical symbol of an alert over a bed) is backlit by a corresponding light 62a when an exit detection system is armed; a second icon 60b (e.g., a graphical symbol of an eye) is backlit by a second light 62b when a monitoring system is armed; a third icon 60c (e.g., a graphical symbol of an arrow and bed) is backlit by a third light 62c when litter frame 28 is at its lowest height (or below a threshold height); a fourth icon 60d (e.g., a graphical symbol of an unplugged AC power cord) is backlit by a fourth light 62d when the patient support apparatus 20 is plugged into an electrical wall outlet; and a fifth icon 60e (e.g., a graphical symbol of a lock and wheel) is backlit by a fifth light 62e when the brake is activated.

The lights 62 positioned behind these icons 60a-e may be controlled to be illuminated in different colors, depending upon what state the associated condition is currently in (e.g. the brake is deactivated, exit detection system 130 is disarmed, etc.) and/or one or more of them may alternatively not be illuminated at all when the associated condition is in another state. Additionally, the brightness level of lights 62 is adjustable such that, regardless of color, the intensity of the light emitted from lights 62 may be varied by a controller onboard patient support apparatus 20, as will be discussed in greater detail below.

Fewer or additional icons 60 may be included as part of dashboard 58 (FIG. 2). The plurality of icons 60 may be dead-fronted on the dashboard 58 of control panel 54a such that the plurality of icons 60 are only visible by the caregiver when illuminated by icon lights 62 supported in the housing of control panel 54a. In some embodiments, dashboard 58 retains the illumination of one or more of icons 60a-e at all times. That is, in some embodiments, display 52 is configured to go to sleep (blank) after a predetermined time period elapses without usage. Dashboard 58, however, retains the illumination of the various icons 60 even after display 52 goes blank, thereby providing the caregiver with information about the status of patient support apparatus 20 when display 52 is blank. Thus, for example, if the brake is not activated and icon 60e is illuminated with an amber or red color, this illumination remains for as long as the brake remains inactive, even if display 52 times out and goes to sleep (or otherwise goes blank).

Still referring to FIG. 2, one or more reflective surfaces 64 may be located on the patient support apparatus 20 proximate control panel 54a. The reflective surfaces 64 may be disposed relative to control panel 54a such that one or more indirect lights 66 supported by the housing of control panel 54a project light away from control panel 54a toward the reflective surfaces 64 to be reflected off the reflective surfaces 64 and outward from the patient support apparatus 20 to act as another visual indicator. Indirect lights 66 may be located on a bottom of the housing of control panel 54a to project the light away from the bottom of the housing toward the reflective surfaces 64. Accordingly, indirect lights 66 may be hidden from view by a housing of control panel 54a. The light may be reflected, for example, in several directions, including generally horizontal directions, for being easily viewed by a caregiver at a distance from the patient support apparatus 20. As shown in FIG. 2, in one example, reflective surface 64 is disposed underneath control panel 54a to reflect light away from the patient support apparatus 20. Reflective surface 64 is a surface of the footboard 34, although it may be any surface capable of reflecting light from indirect lights 66, and may be present elsewhere on the patient support apparatus 20. Similar reflective surfaces 64b may be present on one or more of the siderails 36 to reflect light from other control panels 54.

Reflective surfaces 64 are adapted in many embodiments to generate diffuse reflection, rather than specular reflection. That is, surfaces 64 are not mirrored surfaces, but instead are colored surfaces that scatter the light emitted from lights 66 in multiple directions and/or at many angles. In many embodiments, surfaces 64 are colored a white color, or an off-white color, such that the color composition of the light emitted by indirect lights 66 is not substantially changed after reflection from surfaces 64. The color of light emitted by indirect lights 66 is variable, and in several embodiments, comprises the same color palette as icon lights 62. For example, in at least one embodiment, indirect lights 66 may emit light of three different colors: amber, red, and green, and icon lights 62 are also able to emit light of the same three colors. It will be understood that the term “light” as used herein is broad enough to cover multiple LEDs, bulbs, or other light emitting structures, such that the term “light” includes structures wherein one LED, bulb, or the like is used for emitting a first color, a second LED, bulb, or the like is used for emitting a second color, and so on.

Indirect lights 66 are configured to emit light constantly at certain times, to emit light in a pulsed fashion at other times, and to emit light in a flashing fashion at still other times. When the lights 66 are pulsed, the intensity of the emitted light follows a generally sinusoidal function. When the lights 66 are flashed, the intensity of the lights generally follows a square wave function. For each of these types of illumination—constant, pulsing, and flashing—the brightness level of the light emitted by indirect lights 66 may be varied. That is, when the lights are pulsed, the highest amplitude of the sinusoidal function may be varied; and when the lights are flashed, the non-zero level of the square wave function may also be varied. As a result, both the pulsing and the flashing of the lights 66 may be carried out at different intensity levels. As will be discussed in greater detail below, patient support apparatus 20 is configured, in at least some embodiments, to automatically adjust the brightness level of the pulsing and flashing of lights 66 (as well as the constant illumination of these lights 66). The times at which indirect lights 66 are illuminated, as well as their manner of illumination and the intensity of that illumination, are discussed in greater detail below.

Both icon lights 62 and indirect lights 66 may comprise RGB LEDs (“Red-Green-Blue Light Emitting Diodes”). Icon lights 62 and/or indirect lights 66 may comprise a single RGB LED, or may comprise a plurality of LEDs. Icon lights 62 and indirect lights 66 may also comprise one or more incandescent bulbs, halogen lamps, neon lamps, fluorescent tubes, and/or any other types of light emitting devices whose intensity can be controlled. In some embodiments, patient support apparatus 20 includes one or more direct lights 68 located on the sides of control panel 54a that emit light through light-transmitting covers attached to the housing of control panel 54a (FIG. 2). When included, direct lights 68 are controlled in synchrony with indirect lights 66, as will be discussed in greater detail below.

FIG. 2 illustrates one example of a motion control screen 71 that is displayable on display 52 of patient support apparatus 20. Motion control screen 71 is displayed in response to a user navigating to it, such as by pressing on navigation control 50d. In some embodiments, motion control screen 71 may be the default screen which is initially displayed on display 52 and/or it may be the screen to which display 52 automatically returns after a predetermined time period of inactivity.

Motion control screen 71 includes a plurality of motion controls 72 for controlling the movement of patient support apparatus 20. Specifically, it includes a chair control 72a for moving patient support apparatus 20 to a chair configuration; a flat control 72b for moving patient support apparatus 20 to a flat orientation; a set of Fowler lift and lower controls 72c and 72d; a set of gatch lift and lower controls 72e and 72f; a litter frame lift control 72g; a litter frame lower control 72h; a Trendelenburg control 72i; and a reverse Trendelenburg control 72j. In some embodiments of patient support apparatus 20, motion control screen 71 are dedicated controls that are separate from display 52.

Control panel 54a (FIG. 2) also includes an ambient light opening 70 that is adapted to allow ambient light to enter therein. As will be discussed in greater detail below, an ambient light sensor is contained within a housing of control panel 54a and positioned such that it detects ambient light entering ambient light opening 70. Although FIG. 2 illustrates only a single ambient light opening 70, it will be understood that control panel 54a may be modified to include a plurality of ambient light openings 70 (along with a plurality of corresponding ambient light sensors). In at least one embodiment, control panel 54a includes three ambient light openings 70 and three corresponding ambient light sensors. In some such embodiments, at least one of the ambient light openings 70 is positioned vertically above display 52. Another ambient light opening 70 may be positioned to a left side of display 52 in a position symmetrical with the ambient light opening 70 shown in FIG. 2. Still other locations for ambient light openings 70 and their associated ambient light sensors may be utilized.

FIG. 3 illustrates control panel 54a in an exploded perspective view. As shown therein, it can be seen that control panel 54a includes a front housing 74, a touchscreen sensor 76, a gasket 78, a display layer 80, a bracket 82, a circuit board 84, a light board 86, a back housing 88, a ground strap 90, a conductive adhesive 92, a flexible cable 94, a plurality of fasteners 96, a lens 98, and a cable connector 100. Front housing includes icons 60a-e, controls 50a-f, a transparent section 102 aligned with display layer 80, translucent sections 104 (only one visible) that form pathways for viewing direct lights 68, and ambient light sensing opening 70. Touch sensor 76 is adapted to sense the location of a user's touch on transparent section 102. Touch sensor 76 may be a conventional touch sensor used in conventional touchscreens.

Display layer 80 may be, as noted previously, a Liquid Crystal Display (LCD), or some other type of display layer. Bracket 82 includes a plurality of dashboard openings 106. Dashboard openings 106 provide openings for icon lights 62, which are mounted to light board 86, to emit light through, thereby illuminating icons 60a-e. Bracket 82 also includes a plurality of control openings 108. Control openings 108 provide openings for a plurality of control lights 56, which are mounted to circuit board 84, to emit light through, thereby illuminating controls 50. Lens 98 disperses light from indirect lights 66 onto reflective surface 64.

Circuit board 84 also includes an ambient light sensor 110 that is positioned thereon at a location that aligns with ambient light opening 70. Bracket 82 includes an ambient light opening 122 that is also aligned with ambient light opening 70 and ambient light sensor 110. Light opening 122 thereby defines a tunnel through which ambient light that enters opening 70 is able to pass on its way to ambient light sensor 110. Ambient light sensor is electrically coupled to a controller (not shown) that is mounted on circuit board 84, as will be discussed in greater detail below.

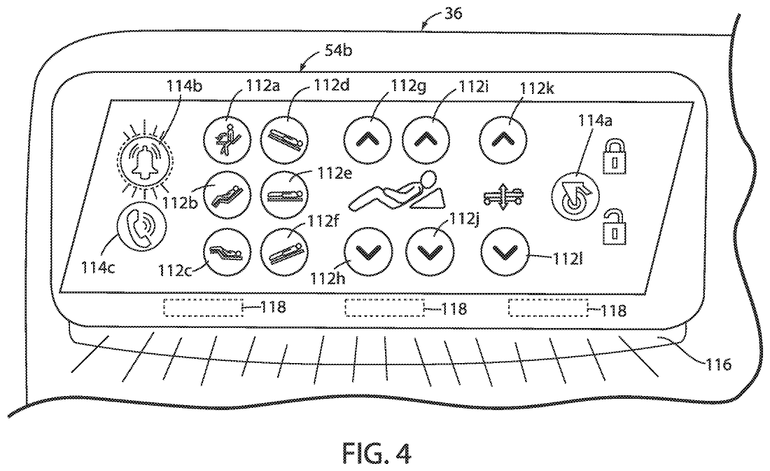

As was noted previously, in some embodiments, additional control panels may be present on the patient support apparatus 20, spaced from control panel 54a. FIG. 4 depicts a plan view of one of the control panels 54b attached to a head end one of the siderails 36. A similar control panel 54b may be located on an opposing head end siderail 36. Control panel 54b includes a plurality of controls 112 and one or more visual indicators 114. The controls 112 include a plurality of preset configuration controls 112a-f and a plurality of motion controls 112g-l. The indicators 114 include a brake indicator 114a, an alarm indicator 114b, and a nurse call indicator 114c.

Preset configuration control 112a (FIG. 4), when pressed, causes motorized actuators (not shown) aboard patient support apparatus 20 to move litter frame 28 and deck 30 into a patient egress position that allows easier exit for the patient from patient support apparatus 20. The same control 112a can also be employed to allow easier ingress into the patient support apparatus 20. Preset recline control 112b, when pressed, causes the motorized actuators to move litter frame 28 and deck 30 to a reclined position, such as shown by the icon in the center of recline control 112b. Preset leg raised control 112c, when pressed, causes the motorized actuators to move litter frame 28 and deck 30 such that the legs of the patient are bent and oriented higher than the patient's torso, such as shown by the icon in the center of leg raised control 112c.

Preset Trendelenburg control 112d, when pressed, causes the motorized actuators to move litter frame 28 and deck 30 to the Trendelenburg position. Preset flat control 112e, when pressed, causes the motorized actuators to move litter frame 28 and deck 30 to a flat orientation. Preset reverse Trendelenburg control 112g, when pressed, causes the motorized actuators to move litter frame 28 and deck 30 to the reverse Trendelenburg position.

Controls 112g and 112h (FIG. 4) move the gatch portion of the support deck 30 up and down, respectively. Controls 112g and 112h carry out the same function as controls 72e and 72f of control panel 54a (FIG. 2). Controls 112i and 112j move the Fowler section 44 of support deck 30 up and down, respectively. Controls 112i and 112j carry out the same function as controls 72c and 72d of control panel 54a. Controls 112k and 112l raise and lower the entire litter frame 28, respectively. Controls 112k and 112l carry out the same function as controls 72g and 72h of control panel 54a.

Control panel 54b also includes indicators 114a, 114b, and 114c. Indicator 114a is illuminated in a first manner (e.g. a red or amber light) when a brake onboard patient support apparatus 20 is not activated, and in another manner (e.g. green) when the brake is activated. Indicator 114b, in some embodiments, is illuminated in order to remind a caregiver to arm or disarm an exit detection system onboard patient support apparatus 20. In at least one such embodiment, indicator 114b emits white light (steady, flashing, or pulsing) when a user presses on egress control 112a while the exit detection system is armed, and emits no light at all other times except when the exit detection system is armed and detects a patient exiting from patient support apparatus 20. When such a patient exit is detected, indicator 114b may be activated to emit a red flashing light. The red flashing illumination of indicator 114b during an exit detection alert is configured, in at least some embodiments, to be synchronized with the red flashing of other lights (e.g. indirect lights 66) that also may occur when an exit detection alert is issued. Such synchronization means that not only is indicator 114b activated at the same times as the other lights, but the waveform used to carry out the flashing (non-sinusoidal) is of the same period, frequency, and general shape (although the amplitude may be different). Other manners of illuminating indicator 114b may also be employed.

Indicator 114c is illuminated when a patient makes a call to a remotely positioned nurse. In some embodiments, indicator 114c is illuminated a first color when such a call is placed and illuminated a second color when no such call is placed. In other embodiments, indicator 114c is not illuminated when no call is being placed, and is illuminated when such a call is placed.

Still referring to FIG. 4, at least one reflective surface 116 is located on the siderails 36 and beneath control panel 54b. The reflective surface 116 is disposed relative to control panel 54b such that one or more indirect lights 118 supported by the housing of control panel 54b project light away from control panel 54b toward the reflective surface 116 to be reflected off the reflective surface 116 and outward from the side rails to act as another visual indicator.

Indirect lights 118 are located on a bottom of the housing of control panel 54b and project light away from the bottom of the housing toward the reflective surface 116. Accordingly, indirect lights 118 are hidden from view by the housing. The light they emit is reflected, for example, in several directions, including generally horizontal directions, for being easily viewed by a caregiver at a distance from the patient support apparatus 20. Reflective surface 116, like reflective surface 64, is a diffuse reflector, not a specular reflector, and is, in at least some embodiments, the same color as reflective surface 64.

Each control 112 and indicator 114 of control panel 54b is adapted to be illuminated by one or more control panel lights 120 (FIG. 5). The control panel lights 120 are positioned inside a housing of control panel 54b and emit light outwardly through the respective controls 112 and indicators 114 such that these controls 112 and 114 are illuminated. In some embodiments, all of the controls 112 are illuminated by a single control panel light 120, while the indicators 114 are each illuminated by their own separate and independently controllable lights 120. In still other embodiments, one or more individually controllable lights 120 may be provided for any one or more of controls 112 and/or indicators 114. As noted, in some embodiments, the lights 120 are able to emit light of different colors, thereby changing the color at which controls 112 and/or indicators 114 are illuminated. The control panel lights 120 are configured such that the brightness of the light they emit can be controlled.

In some embodiments, icon lights 62, indirect lights 66, direct lights 68, and indirect lights 118 are all controlled to emit light in synchronized manners at different times, depending upon the state of patient support apparatus 20. For example, in some embodiments, icon lights 62, indirect lights 66, direct lights 68, and indirect lights 118 are activated continuously at times, are flashed in unison at other times, and are pulsed in unison at still other times. As used herein, the term “pulsing” or its variants refers to controlling the illumination of one or more lights such that its light intensity increases and decreases in a generally sinusoidal manner. That is, the light gradually gets brighter and brighter until it reaches a peak and then gradually gets dimmer and dimmer until it reaches a trough (which may have the light completely shut off for a fleeting moment), and then this cycle repeats. In contrast, the term “flashing” refers to changing the intensity of the lights, but in a manner that is much more precipitous. For example, in some embodiments, “flashing” refers to controlling the lights such that the intensity of the light they emit generally varies in a square wave fashion. Alternatively, flashing of the lights may be carried out such that the emitted light intensity varies generally as a sawtooth wave, or as a triangle wave, or in some other non-sinusoidal manner. By using a non-sinusoidal wave form for flashing the lights, the effect is to present a visually harsher and more immediate sense of urgency to the caregiver than the sinusoidal waveform used during the pulsing of the lights.

As was noted previously, whether icon lights 62, indirect lights 66, direct lights 68, and indirect lights 118 are being flashed or pulsed, the intensity of the light emitted from these lights during such flashing or pulsing can be varied. That is, these lights are controllable such that they flash at different intensity levels (e.g. the peak amount of light emitted during the flashing cycle can be varied). Similarly, these lights are controllable such that they pulse at different intensity levels (e.g. the generally sinusoidal amplitude of the light emitted can take on different peak values). Thus, these lights can be both flashed and pulsed at different brightness levels, in at least some embodiments.

The flashing of these lights may also be carried out at a higher frequency than the pulsing of the lights. In at least one embodiment, the pulsing of lights 62, 66, 68, and 118 repeats itself with a frequency on the order of once every two to five seconds, although other frequencies may be used. By pulsing at this frequency, the synchronized illumination of lights 62, 66, 68, and 118 changes its intensity with roughly the same frequency as a human breathes, and this relatively low time period creates a non-urgent, yet persistent, visual effect, thereby reminding the caregiver that one or more tasks still need to be completed to put patient support apparatus 20 in the proper configuration, yet doing so in a manner that is not distractive or unappealing to the caregiver. In contrast, the synchronized flashing of lights 62, 66, 68, and 118 is carried out, in at least one embodiment, at a frequency faster than once every two to five seconds, such as, but not limited, to, at least once per second, if not faster. As will be discussed more below, the flashing of lights is typically only implemented when an alert has issued (red flashing when the exit detection system detects a patient alert; amber flashing when an onboard monitoring system detects an alert with respect to a monitored condition), while the pulsing of the lights (amber) is typically only implemented when a reminder is being communicated to the caregiver to perform one or more configuration tasks with respect to patient support apparatus 20.

In some embodiments, the synchronized control of lights 62, 66, 68, and 118, or a subset of these lights, is carried out in any of the manners disclosed in more detail in commonly assigned U.S. patent application Ser. No. 62/864,638 filed Jun. 21, 2019 by inventors Kurosh Nahavandi et al. and entitled PATIENT SUPPORT APPARATUS WITH CAREGIVER REMINDERS, the complete disclosure of which is incorporated herein by reference. In other embodiments, the illumination of lights 62, 66, 68, and/or 118 may be carried out in different manners.

FIG. 5 illustrates one example of a control system 124 for patient support apparatus 20. Control system 124 includes a controller 126, a power source 128, controls panels 54a, b, and c (only two of which—54a and one example of 54b—are shown in FIG. 5), dashboard 58, an exit detection system 130, a plurality of sensors 132a-e, one or more ambient light sensors 110, a manual brightness control 134, a nurse call interface 136, and a network transceiver 138.

Controller 126 may take on a variety of different forms. In the illustrated embodiment, controller 126 is implemented as a conventional microcontroller. However, controller 126 may be modified to include one or more other types of circuits—either alone or in combination with one or more microcontrollers—such as, but not limited to, any one or more microprocessors, field programmable gate arrays, systems on a chip, volatile or nonvolatile memory, discrete circuitry, and/or other hardware, software, or firmware that is capable of carrying out the functions described herein, as would be known to one of ordinary skill in the art. Such components can be physically configured in any suitable manner, such as by mounting them to one or more circuit boards, or arranging them in other manners, whether combined into a single unit or distributed across multiple units. The instructions followed by controller 126 when carrying out the functions described herein, as well as the data necessary for carrying out these functions, are stored in a corresponding memory 140 that is accessible to controller 126. As will be discussed in greater detail below, controller 126 may be programmed to control the illumination, including the brightness levels, of lights 118, 120, 56, 62, 68, and 66, as well as the brightness and content of display 52. Controller 126 also is programmed to control control panels 54a-c.

Power to the patient support apparatus 20 is provided by either an external power source 142 or a battery 144 (FIG. 5). An alternating current (A/C) power cord 146 provides power from the external power source 142 to the patient support apparatus 20 and is plugged into a corresponding outlet (e.g., a conventional wall power outlet) to receive external power.

Network transceiver 138 of control system 124 (FIG. 5) may be a wireless network transceiver, such as, but not limited to, a Wi-Fi transceiver adapted to wirelessly communicate with one or more wireless access points 150 of a conventional healthcare facility's local area network 152. Controller 126 is thereby able to use network transceiver 138 to send signals to and receive signals from one or more servers located on hospital network 152.

Patient support apparatus 20 also includes a nurse call interface 136 for communicatively coupling patient support apparatus 20 to a conventional nurse call system 154. Conventional nurse call systems typically include one or more nurse call outlets 156 positioned in each patient room that are electrically coupled to one or more centralized components of the nurse call system 154, thereby enabling patient support apparatus 20, when coupled to an outlet 156, to communicate with the nurse call system 154. In some embodiments, nurse call interface 136 of patient support apparatus 20 is a wired interface adapted to couple to, and communicate with, nurse call outlet 156 via a nurse call cable 158. A first end of cable 158 is coupled to nurse call interface 136 and the other end is coupled to nurse call outlet 166. One example of such a wired nurse call interface is the cable interface disclosed in more detail in commonly assigned U.S. Patent Application Publication No. 2018/0293849, filed on Apr. 4, 2018 and entitled PATIENT SUPPORT APPARATUSES WITH RECONFIGURABLE COMMUNICATION, the complete disclosure of which is incorporated herein by reference.

In other embodiments, nurse call interface 136 is a wireless interface adapted to communicate wirelessly with nurse call outlet 156. Several examples of wireless nurse call interfaces 136 that enable wireless communication between patient support apparatus 20 and an adjacent nurse call outlet 156 are disclosed in the following commonly assigned patent references and may be implemented in patient support apparatus 20 herein: U.S. Patent Application Publication No. 2016/0038361, filed on Aug. 6, 2015 and entitled PATIENT SUPPORT APPARATUSES WITH WIRELESS HEADWALL COMMUNICATION; U.S. patent application Ser. No. 16/217,203, filed on Dec. 12, 2018 and entitled SMART HOSPITAL HEADWALL SYSTEM; U.S. patent application Ser. No. 16/193,150, filed on Nov. 16, 2018 and entitled PATIENT SUPPORT APPARATUSES WITH LOCATION/MOVEMENT DETECTION; and U.S. patent application Ser. No. 16/215,911, filed on Dec. 11, 2018 and entitled HOSPITAL HEADWALL COMMUNICATION SYSTEM, the complete disclosures of all of which are incorporated herein by reference. Still other types of wireless or wired nurse call interfaces may, of course, be used.

Exit detection system 130 of control system 124 (FIG. 5) is adapted to determine if the occupant of patient support apparatus 20 has exited therefrom. Exit detection system 130 may include a plurality of force sensors, such as load cells (not shown) that detect the weight of the patient when the patient is supported on support deck 30. In some embodiments, these force sensors are used to determine a center of gravity of the occupant in order to determine if the occupant is about to exit patient support apparatus 20. In alternative embodiments, the outputs from the force sensors are analyzed, not to determine a center of gravity, but instead to determine a weight distribution and/or a change in weight distribution, such as by determining one or more ratios of the relative weights sensed by the force sensors on opposite sides (and/or opposite ends) of patient support apparatus 20 and using them to determine if the occupant is about to exit patient support apparatus 20. In still other embodiments, other types of sensors may additionally or alternatively be used for determining if the patient has exited, or is about to exit.

The particular structural details of exit detection system 130 can vary widely. In some embodiments, exit detection system 130 is constructed in accordance with the exit detection system described in U.S. Pat. No. 5,276,432, issued Jan. 4,1994, entitled PATIENT EXIT DETECTION MECHANISM FOR HOSPITAL BED, the complete disclosure of which is hereby incorporated herein by reference. In such embodiments, exit detection system 130 may include multiple zones that trigger an alert when the patient's center of gravity travels outside of the zone. In this manner, exit detection system 130 is able to have its sensitivity selected by the caregiver. Other types of exit detection systems may also or alternatively be used.

Exit detection system 130 is configured to be armed and disarmed. When armed, exit detection system 130 issues an alert when the occupant exits patient support apparatus 20, or is about to exit patient support apparatus 20. In response to the alert issued by exit detection system 130, controller 126 is configured to flash indirect lights 66, direct lights 68, icon light 62a, indirect lights 118 and, in some embodiments, indicator 114b. Controller 126 may also display an exit detection alert screen on display 52 which includes portions that are red or amber and that flash in synchrony with lights 66, 68, 62a, 118, and 114b.

Sensors 132a-e (FIG. 5) detect the states of various components of patient support apparatus 20 and report those current states to controller 126. Side rail sensors 132a output signals that indicate a current position of siderails 36. The current position may be a raised position (up), a lowered position (down), or an intermediate position. HOB angle sensor 132b outputs signals that indicate a current angle of Fowler section 44 so that controller 126 can determine whether the Fowler section 44 is at or above a preset angle relative to the litter frame 28. Height sensor 132c outputs signals that indicate a current height of litter frame 28 so that controller 126 can determine whether litter frame 28 is at its lowest height or not. Brake sensor 132d outputs signals that indicate whether the brake is active (on) or inactive (off). Power source sensor 132e outputs signals that indicate whether or not the AC power plug that provides power from the external power source 142 to patient support apparatus 20 is plugged into a corresponding outlet (e.g., a wall outlet) to receive external power.

These sensors 132a-e may include one or more load cells, pressure sensors such as piezoelectric and piezoresistive sensors, Hall Effect sensors, capacitive sensors, resonant sensors, thermal sensors, limit switches, gyroscopes, accelerometers, motion sensors, ultrasonic sensors, range sensors, potentiometers, magnetostrictive sensors, electrical current sensors, voltage detectors, and/or any other suitable types of sensors for carrying out their associated functions.

Control system 124 further includes one or more ambient light sensors 110 (FIG. 5) and, in some embodiments, a manual brightness control 134. Manual brightness control 134 may be a conventional button, switch, or knob that is manually manipulated by a user when he or she wishes to dictate the level of brightness of display 52. In some embodiments, manual brightness control 134 may be an icon, or other graphic, displayed on display 52 that, when activated, allows the user to select how brightly display 52 should be illuminated. As will be discussed in greater detail below, in some embodiments, when the user selects a level of brightness using manual control 134, controller 126 is also configured to make corresponding adjustments to the brightness of other lights onboard patient support apparatus 20, such as, but not limited to, any of lights 56, 62, 66, 68, 118, and/or 120. In other embodiments, manual brightness control 134 may be configured such that it changes the brightness of both display 52 and one or more additional lights (e.g. 56, 62, 66, 68, 118, and/or 120, or it may be configured such that it only changes the brightness of display 52 and leaves unaffected the brightness of one or more of lights 56, 62, 66, 68, 118, and/or 120.

Manual brightness control 134, in some embodiments, is adapted to not only allow a user to select a user-defined brightness level, but also to toggle between a user-defined brightness level and a brightness level that is automatically determined by controller 126. In such embodiments, the user deactivates manual brightness control 134 if he or she wants controller 126 to automatically select a brightness level, and activates manual brightness control 134 (and uses it to select a desired brightness level) if he or she wishes to manually control the brightness level. In still other embodiments, manual brightness control 134 may be split up into multiple separate controls, such as a first one for activating and deactivating the manual brightness control, and a second one for selecting the desired brightness level when the manual brightness control has been activated.

Controller 126 uses the outputs of sensors 132a-e and exit detection system 130 (FIG. 5) to control the illumination of icon lights 62a-e. Still further, controller 126 uses the outputs of sensors 132a-e, as well exit detection system 130, to control the illumination of one or more of lights 56, 66, 68, 118, and/or 120. Thus, for example, in some embodiments, when exit detection system 130 detects a patient exit and issues an alert, controller 126 is configured to flash only the light 62a positioned behind icon 60a (which corresponds to the exit detection system 130). The lights 62b-e positioned behind the other icons 60b-e may remain activated (or deactivated) in whatever manner in which they were previously activated (or deactivated) immediately prior to the exit detection alert. Thus, for example, if the icon light 62e positioned behind brake icon 60e was previously activated to display a steady green color prior to exit detection system 130 issuing an alert, controller 126 is configured in at least one embodiment to continue to keep light 62e steadily activated with a green color while it flashes the light 62a (red) behind exit detection alert icon 60a during the exit detection alert.

Controller 126 also uses the outputs of sensors 132a-e and exit detection system 130 to control what content is displayed on display 52. For example, controller 126 may display one or more alert screens on display 52 when an alert condition is detected, or one or more reminder screens when one or more conditions needing to be remedied are detected (e.g. brake is not set, power cord is not plugged in, etc.). Some examples of these types of screens are disclosed in commonly assigned U.S. patent application Ser. No. 62/864,638 filed Jun. 21, 2019, by inventors Kurosh Nahavandi et al. and entitled PATIENT SUPPORT APPARATUS WITH CAREGIVER REMINDERS, the complete disclosure of which is incorporated herein by reference. Other screens may also or alternatively be displayed.

Control panel 54a communicates with controller 126 and allows the caregiver to control various aspects of exit detection system 130, such as, but not limited to, arming or disarming exit detection system 130, customizing a setting of exit detection system 130, such as customizing a sensitivity level of exit detection system 130, and cancelling an alert issued by exit detection system 130. Other customizable settings for exit detection system 130 are possible.

Control panel 54a also allows a user to control an onboard monitoring system 160 (FIG. 5). For example, when a user presses on control 50b, controller 126 is configured to display one or more screens on display 52 that allow a user to activated, deactivate, and/or configure the onboard monitoring system 160. The onboard monitoring system 160 comprises a collection of sensors and a processing unit, such as controller 126, that processes the outputs from the collection of sensors (e.g. sensors 132a-d) to determine if any one or more of the components monitored by the sensors are in an undesired state. If any one or more are in an undesired state, and monitoring system 160 is armed, controller 126 issues an alert. In some embodiments, monitoring system 160 includes side rail sensors 132a, HOB angle sensors 132b, height sensors 132c, and brake sensors 132d. Other types of sensors may additionally or alternatively be used for determining the state of one or more monitored conditions of the patient support apparatus 20. The particular structural details of monitoring system 160 can vary widely. An exemplary monitoring system is described in U.S. Pat. No. 8,844,076, filed on Jan. 27, 2014, entitled PATIENT HANDLING DEVICE INCLUDING LOCAL STATUS INDICATION, ONE-TOUCH FOWLER ANGLE ADJUSTMENT, AND POWER-ON ALARM CONFIGURATION, the complete disclosure of which is hereby incorporated herein by reference. Other types of monitoring systems may be used.

Monitoring system 160 is configured to be armed and disarmed. When armed, monitoring system 160 issues an alert when at least one monitored condition of the patient support apparatus 20 is in an undesired state, which may include when one or more of the side rails are down, when the HOB angle is less than the preset angle, when the support deck 30 and/or litter frame is not flat, or when the brake are not engaged. Controller 126 is configured, in at least one embodiment, to synchronously flash lights 62b, 66, 68, and 118 in an amber color when monitoring system 160 issues an alert.

Control panel 54a communicates with controller 126 and enables the caregiver to control one or more aspects of monitoring system 160. Control panel 54a allows the caregiver to control various aspects of monitoring system 160, such as, but not limited to, navigating to a monitoring system control screen, arming or disarming monitoring system 160, and cancelling an alert issued by monitoring system 160. Display 52 displays information regarding monitoring system 160, such as, but not limited to, displaying a monitor control screen, and displaying an alert issued by monitoring system 160.

During operation of patient support apparatus 20, controller 126 is configured to repetitively check to see whether each component in a set of components is in its desired state and, if any one or more of them are not, to issue a reminder to the caregiver to place the components in their desired state. The reminder may take the form of synchronously pulsing one or more of lights 62, 66, 68, and/or 118. In at least one embodiment, the set of components and their desired states includes the following: exit detection system 130 (armed); monitoring system 160 (armed), a brake (activated), and power cord 146 (plugged into an electrical outlet). It will be understood that this set of components may be varied in different embodiments and that, in some of those different embodiments, the set of components that are repetitively monitored by controller 126 for reminder purposes may be customized by users of patient support apparatus 20. It will further be understood that the monitoring of the set of components for reminder purposes is carried out automatically and repetitively at all times that patient support apparatus 20 is powered on, and not just at times when display 52 is in a wake mode.

Still further, it will be understood that the repetitive monitoring of the set of components for reminder purposes is different from the monitoring that is carried out by monitoring system 160. The monitoring that is carried out by monitoring system 160 is only carried out when monitoring system 160 is armed. Additionally, the monitoring that is carried out by system 160 may be of a different set of components and/or conditions than the set of components that controller 126 monitors for reminder purposes. For example, in many embodiments, monitoring system 160 monitors the position of one or more siderails 36, while controller 126 is not configured to monitor the side rails (in at least one embodiment) for reminder purposes. Still further, the consequences of the monitoring carried out by controller 126 for purposes of reminders and for purposes of monitoring system 160 are different. If controller 126 detects a component that is in an undesired state for purposes of its reminder monitoring, it issues a reminder by pulsing one or more lights. In contrast, if controller 126 detects a component that is in an undesired state as defined by monitoring system 160, it issues an alert, rather than a reminder, and flashes one or more lights. That is, controller 126 is configured, in at least some embodiments, to flash lights 62, 66, 68, and/or 118 in response to an alert, and to pulse lights 62, 66, 68, and/or 118 in response to a reminder.

In addition to issuing a reminder via the pulsing of lights 62, 66, 68, and/or 118, controller 126 is configured to issue a reminder by displaying a reminder screen on display 52. The particular reminder screen is, in at least one embodiment, different for each of the different components that patient support apparatus 20 is configured to issue reminders for. Thus, for example, if the brake is deactivated, controller 126 displays a brake reminder screen, and if AC power cord 146 is not plugged in, controller 126 displays an AC power cord reminder screen that is different.

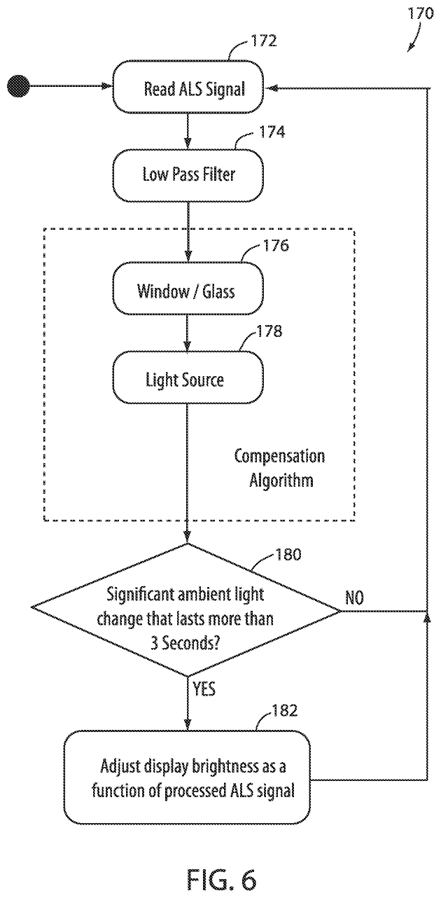

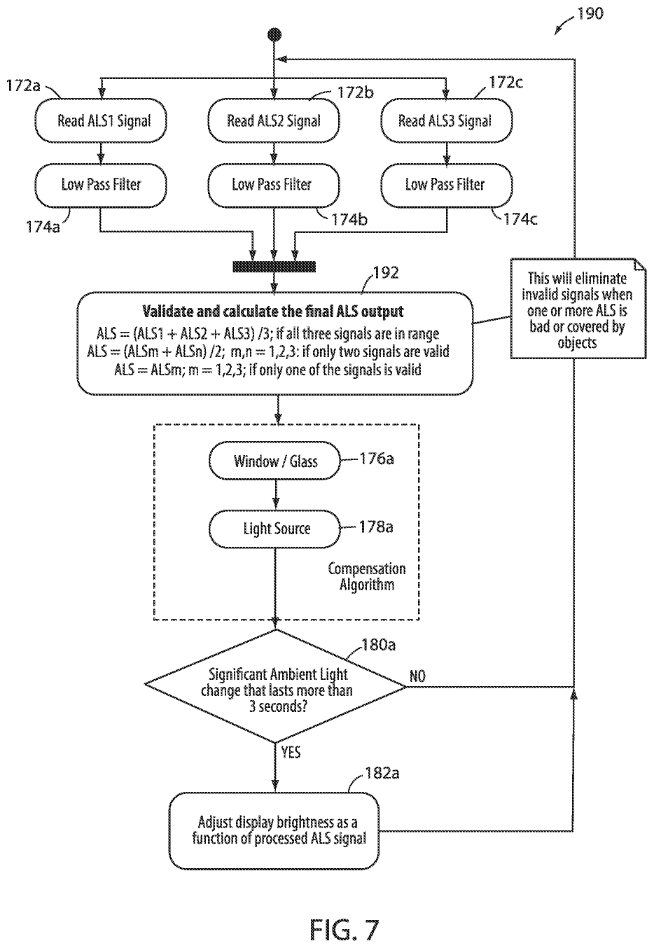

As was noted previously, controller 126 is configured to control the brightness of display 52, as well as, in at least some embodiments, the brightness of one or more of lights 56, 62, 66, 68, 118, and/or 120. When a user activates manual brightness control 134, controller 126 controls the brightness of display 52 and the aforementioned lights according to a user-selected brightness level. When the user does not activate manual brightness control 134, controller 126 automatically adjusts the brightness of display 52 and the aforementioned lights according to the amount of ambient light sensed by ambient light sensor 110. Different manners in which controller 126 carries out these automatic brightness adjustments are discussed below with respect to FIGS. 6 and 7.

FIG. 6 illustrates a first brightness control algorithm 170 executed by controller 126 when manual brightness control 134 has not been activated. Brightness control algorithm 170 starts at step 172 where it acquires light level readings from the ambient light sensor 110. At step 174, the ambient light level readings from step 172 are low pass filtered. The low pass filtering is designed to remove transient changes in the light level readings that may be due to passing shadows, or other causes. Low pass filter step 174 therefore removes high frequency changes from the ambient light level readings obtained at step 172.

At steps 176 and 178, controller 126 applies compensation factors to the filtered, ambient light readings that are output from step 174. More specifically, at step 176, controller 126 applies one or more compensation factors to the outputs from step 174 that are designed to account for the type of glass, or other translucent material, that is positioned over ambient light opening 70. Thus, for example, if a dark piece of glass is positioned over ambient light opening 70 that filters out a relatively large percentage of the ambient light, controller 126 may be programmed at step 176 to amplify the signals from step 174 in order to account for the diminution in the signals due to the darkened glass that covers opening 70. At step 176, controller 126 therefore adjusts the ambient light level readings based on the optical characteristics of ambient light opening 70 and any covering that is placed therein. The particular adjustment is typically based upon empirical data gathered from ambient light sensor 110 when patient support apparatus 20 is placed under different lighting conditions. Alternatively, or additionally, the particular adjustment may be based upon the particular ambient light sensor 110 utilized and its operating characteristics.

At step 178 (FIG. 6), controller 126 is configured to make further adjustments to the ambient light level readings, such as compensations based upon the particular ambient lighting that patient support apparatus 20 is being subjected to (e.g. halogen, fluorescent, incandescent). In some embodiments, controller 126 is configured to automatically detect such types of lighting, such as by detecting the frequency of amplitude changes in the light and/or by the spectral density of the ambient light. Controller 126 uses the type of lighting to further adjust the ambient light level readings such that, as will be discussed further below, the brightness level automatically selected by controller 126 may vary between different ambient light types (e.g. halogen, fluorescent, incandescent).

In addition to the aforementioned compensations adjustments made at steps 176 and 178, controller 126 may further be configured to adjust the ambient light level readings to remove infrared and/or ultraviolet components of the detected light. Such light is not typically detected by the human eye, and is therefore desirably removed from the calculations used to automatically select a brightness level for display 52 (and/or lights 56, 62, 66, 68, 118, and/or 120). The output of step 178 is therefore an ambient light level reading that is substantially devoid of IR and UV components and that has been compensated to account for the optical characteristics of ambient light opening 70 (and any translucent material therein) such that the ambient light level reading accurately reflects the amount of ambient light that the human eye detects adjacent control panel 54a.

It will be understood that, in some embodiments, ambient light sensor 110 may include its own internal compensation circuitry that makes one or more of the aforementioned adjustments to its ambient light readings. In such cases, controller 126 need only perform those adjustments/compensations that are not already performed by the internal circuitry of ambient light sensor 110. Algorithm 170 may therefore be suitably adjusted based upon the particular ambient light sensor 110 that is utilized with patient support apparatus 20.

At step 180 (FIG. 6), controller 126 compares the compensated ambient light level readings from step 178 taken over a set period of time (e.g. three seconds, or so) to a set of compensated ambient light level readings from step 178 that were taken over an immediately prior set period of time (e.g. a preceding three second period of time). Controller 126 determines the difference between these two sets of readings (e.g. the difference, if any, between the average readings over the set time period and the average readings over the immediately preceding set time period), and compares the difference to a threshold. If the difference exceeds the threshold, controller 126 moves to step 182 and adjusts the brightness level of display 52 and/or one or more of lights 56, 62, 66, 68, 118, and/or 120. If the difference does not exceed the threshold, controller 126 returns back to step 172 and repeats the aforementioned steps.

Step 180 therefore functions to determine if a change in ambient lighting conditions that exceeds the threshold persists for more than a set period of time. In the illustrated embodiment, the set period of time is indicated as being three seconds, but it will be understood that this time period may vary. In general, time periods on the order of three to ten seconds may be used. The time period is selected so that controller 126 does not make brightness adjustments to display 52 (and/or lights 56, 62, 66, 68, 118, and/or 120) so often that it may become visually distracting to a user of display 52. Further, step 180 also functions to ensure that changes to the brightness level of display 52 (and/or lights 56, 62, 66, 68, 118, and/or 120) are not made in response to minor changes in the ambient lighting levels, as well as in response to major changes that are fleeting (e.g. that last for less than the predetermined time period). This serves to avoid making changes to the brightness level of display 52 (and/or lights 56, 62, 66, 68, 118, and/or 120) in response to ambient light level readings that may change when a user presses on one or more of controls 50a-f and/or touchscreen display 52, wherein such actions may create a fleeting shadow over ambient light opening 70.

The threshold to which the difference in ambient light level readings is compared at step 180 may vary from embodiment to embodiment. Further, it may vary depending upon how many different brightness levels display 52 is configured to generate. If, for example, display 52 is only operable at a two levels (e.g. a low brightness level and a high brightness level), then algorithm 170 may be adjusted such that a relatively large difference must be detected at step 180 before controller 126 proceeds to step 182 and makes an automatic brightness adjustment. In contrast, if display 52 is operable at a relatively large number of brightness levels (and/or at a continuous, or nearly continuous, set of brightness levels), algorithm 170 may be implemented such that the difference used at step 180 is relatively small, thereby allowing controller 126 to more frequently make minor adjustments to the brightness level of display 52. Still further, the threshold difference in ambient light level readings used at step 180 may also vary depending upon the value of the preset time period such that smaller automatic brightness adjustments may be made when smaller preset time periods are used, and vice versa. Still other modifications are possible.

As was noted previously, when controller 126 moves to step 182, it automatically selects a brightness level for display 52 (and/or lights 56, 62, 66, 68,118, and/or 120) that is based upon the ambient light level readings analyzed at step 180. In general, if the ambient light level readings decrease, controller 126 also decreases the brightness level at step 182, and if the ambient light level readings increase, controller 126 increases the brightness level at step 182. In this manner, display 52 (and/or lights 56, 62, 66, 68, 118, and/or 120) have their intensity increased in brighter ambient lighting conditions, thereby making them more visible amongst the higher ambient light. Conversely, display 52 (and/or lights 56, 62, 66, 68, 118, and/or 120) have their intensity decreased amid lower ambient lighting conditions because such lowered intensity is still visible amid the lower ambient lighting conditions.

It will be understood that the particular brightness level selected by controller 126 at step 182 may be used for controlling the brightness of a variety of different lights. In one embodiment, controller 126 only controls the brightness of display 52 at step 182. In another embodiment, controller 126 only controls the brightness of display 52 and lights 56 at step 182. In still another embodiment, controller 126 only controls the brightness of display 52, control lights 56, and direct lights 68 at step 182. In still another embodiment, controller 126 only controls the brightness of the lights associated with control panel 54a at step 182 (e.g. display 52, control lights 56, indirect lights 66, and direct lights 68), and takes no action with respect to the lights associated with either of control panels 54b (e.g. indirect lights 118 and/or lights 120). Still other combinations of which lights are controlled by controller 126 at step 182 are also possible.

In some embodiments, each of control panels 54b include their own ambient light sensor and controller 126 is configured to execute algorithm 170, or a modified version of algorithm 170, for each of the control panels 54b. In such a modified embodiment, controller 126 adjusts one or more of the lights of control panel 54a (e.g. display 52 and/or lights 56, 62, 66, and/or 68) based on outputs of the ambient light sensor 110 coupled to control panel 54a, and controller 126 independently adjusts one or more of the lights of control panel 54b (e.g. lights 118 and/or 120) based on outputs of the ambient light sensor 110 coupled to that particular control panel 54b. In still other embodiments, a separate controller 126 may be provided for automatically controlling the brightness of the different control panels 54a-c.

FIG. 7 illustrates a modified brightness control algorithm 190 that is executed by controller 126 in an alternative embodiment. Those steps of algorithm 190 that are the same as, or similar to, corresponding steps in algorithm 170 are labeled with the same reference number followed by a letter. Those steps that are new are labeled with a new reference number. Brightness control algorithm 190, like algorithm 170, is executed when the user has not activated the manual brightness control 134.

Brightness control algorithm 190 (FIG. 7) is adapted to be utilized when patient support apparatus 20 includes more than one ambient light sensor 110. In the particular form of algorithm 190 shown in FIG. 7, patient support apparatus 20 includes three ambient light sensors 110. It will be understood that brightness control algorithm 190 can be easily modified to work with patient support apparatuses 20 having only two ambient light sensors 110, and/or with patient support apparatuses 20 having more than three ambient light sensors 110.

Brightness control algorithm 190 begins at steps 172a-c where controller 126 takes ambient light level readings from three different ambient light sensors 110. In some embodiments, all three of the ambient light sensors 110 are positioned on control panel 54a. In other embodiments, one or more of the ambient light sensors 110 are positioned at locations other than control panel 54a. When positioned on control panel 54a, at least one of the multiple ambient light sensors 110 may be positioned vertically above display 52. In such embodiments, the other two ambient light sensors 110 may be positioned on either side (right and left) of display 52. Still other locations for ambient light sensors 110 are possible.

After taking readings from each of the ambient light sensors at steps 172a-c (FIG. 7), controller 126 moves to steps 174a-c, respectively. At steps 174a-c, controller 126 low pass filters each of the ambient light sensor readings in the same manner as it does in step 174 of algorithm 170. That is, the readings from each ambient light sensor 110 are individually low pass filtered. After this low pass filtering takes place, controller 126 moves to step 192. At step 192, controller 126 examines each of the three low-pass filtered ambient light level readings and discards each and any of those readings that are outside of a predetermined range. The predetermined range is selected such that light level readings that are likely erroneous are discarded. These include light readings that are close to zero, which are likely due to an object being placed over the corresponding ambient light sensor opening 70. The predetermined range may also include excessive ambient light level readings that are so high that they are likely inaccurate, or due to some temporary lighting anomaly for which brightness adjustments are not to be made.

If any one or more of the three ambient light level readings are outside of the predetermined range, controller 126 discards those readings at step 192. Controller 126 then averages together the non-discarded ambient light level readings. If none of the ambient light level readings are within the predetermined range, it returns to steps 172a-c. After averaging together the non-discarded ambient light level readings, controller 126 proceeds to steps 176a, 178a, 180a, and 182a.

Steps 176a, 178a, 180a, and 182a (FIG. 7) are the same as steps 176, 178, 180, and 182, respectively, of algorithm 170, except that controller 126 uses the averaged ambient light level readings (from step 192) in carrying out these steps, rather than the ambient light level readings from a single ambient light sensor 110, as it does with algorithm 170. That is, at steps 176a and 178a, controller 126 applies compensation factors to the average light level reading calculated at step 192. After applying these compensation factors, it proceeds to step 180a where it determines if the compensated average light level reading has changed by more than a threshold over the course of a predefined time period (e.g. three seconds, although other time periods may be used). If it has not, controller 126 returns to steps 172a-c. If it has, controller 126 proceeds to step 182a where it automatically selects a particular brightness level for display 52 and then sends a command to display 52 commanding it to switch to that particular brightness levels. As with algorithm 170, controller 126 may, when following algorithm 190, also change the brightness of one or more additional lights (in addition to the brightness of display 52) at step 182a. These additional lights includes, but are not necessarily limited to, lights 56, 62, 66, 68, 118, and/or 120. Those lights that are not adjusted by controller 126 at step 182a either continue to use the same brightness level when illuminated, or, in some embodiments, may have their brightness level adjusted in response to ambient light level readings taken by other ambient light sensors 110.

If a user activates manual brightness control 134 during the execution of any of algorithms 170 or 190, controller 126 is configured to stop executing those algorithms and to switch to using whichever brightness level for display 52 (and/or any of the aforementioned lights 56, 62, 66, 68, 118, and/or 120) the user has selected using manual brightness control 134. Similarly, if the user deactivates the manual brightness control 134, controller 126 is configured to automatically select an appropriate brightness level based on the outputs of one or more ambient light sensors 110 in accordance with algorithms 170 or 190.

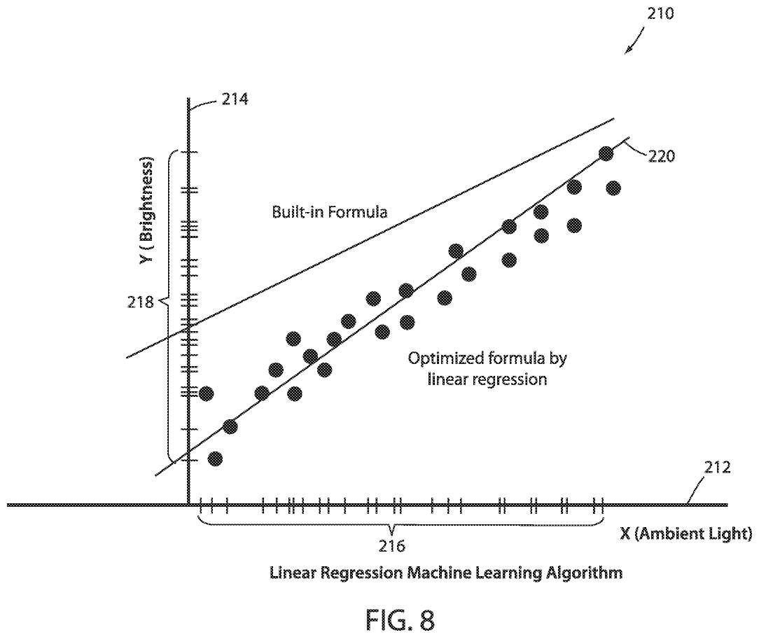

In some embodiments, patient support apparatus 20 may be configured to utilize one or more machine learning algorithms to determine what level of brightness to use when the user has not manually selected a brightness level. In at least one such embodiment, controller 126 is programmed to utilize a linear regression analysis for automatically selected a desired brightness level. This linear regression analysis is better understood with respect to FIG. 8.

FIG. 8 depicts a graph 210 having an X-axis 212 and a Y-axis 214. X-axis 212 corresponds to ambient light sensors readings taken by one or more ambient light sensors 110 and compensated in accordance with any of the manner discussed above with respect to algorithms 170, 190. Y-axis 214 corresponds to brightness levels selected by a user. Controller 126 stores the data shown in FIG. 8 by taking ambient light sensors readings while the manual brightness control 134 is activated, and by recording the user-selected brightness levels that the users select while the manual user control 134 has been activated. In other words, controller 126, over time, stores a set 216 of ambient light sensors readings from ambient light sensor(s) 110. For each ambient light sensor reading of set 216, controller 126 also reads the corresponding brightness level that has been selected by the user at the same time that the ambient light sensor reading was taken. The result of these recordings is that, for the set of ambient light readings 216, controller 126 generates a corresponding second set 218 of brightness levels that were selected by the user.

The data in sets 216 and 218 may be generated and recorded over relatively long periods of time, particularly if the manual brightness control 134 is not used often, and/or if a user does not utilize control panel 54a (or another brightness-controlled control panel) over lengthy periods of time. In at least one embodiment, the data in sets 216 is generated only during a time window surrounding usage of control panel 54a (or some other control panel whose light brightness is adjustable). That is, in some embodiments, controller 126 takes an ambient light sensor reading (or several ambient light sensor readings) in response to a user initially touching, or otherwise interacting with, control panel 54a. This usage is sensed by a user pressing on any of controls 50a-f and/or on display 52 (if it is a touchscreen). When such interaction is detected, controller 126 takes one or several ambient light readings and, in some embodiments, may continue to periodically do so while the control panel 54a (or another brightness controlled control panel is being used). After usage stops for greater than a predetermined amount of time, controller 126 may cease taking such readings until usage resumes again later. For each of the ambient light readings taken, controller 126 also records the brightness level that has been selected by the user.

Over time, controller 126 is able to populate sets 216 and 218 with sufficient data to run a linear regression analysis that seeks to define a linear relationship between the ambient light levels and the user-selected brightness levels for those ambient light levels. Such a linear relationship is shown in FIG. 8 by line 220. After a sufficient number of data points have been gathered, controller 126 is programmed to switch to using line 220 for automatically selecting an appropriate brightness level when the manual brightness control 134 is deactivated. Thus, controller 126 populates sets 216 and 218 while manual brightness control 134 is activated, but utilizes the data in sets 216 and 218 (after they have become sufficiently populated) when manual brightness control 134 is deactivated. Consequently, when data is being gathered for sets 216 and 218, it is being gathered for future usage by controller 126.

In some embodiments, controller 126 is configured to share the data in sets 216, 218 with an offboard server that is in communication with local area network 152 (either hosted thereon, or in communication therewith via an Internet connection). The recipient server may be configured to receive data sets 216, 218 from a plurality of patient support apparatuses 20 positioned within a common healthcare facility, and to collectively use such data to run a linear regression analysis like what is shown in FIG. 8. In other words, in some embodiments, the machine learning that takes place for selecting a brightness level may be offloaded from patient support apparatuses 20 to one or more servers. In such instances, the machine learning is based on data from multiple patient support apparatuses 20, rather than only a single patient support apparatus 20. After sufficient data has been gathered, the results of the server-determined linear regression analysis are shared with each of the patient support apparatuses 20 within the facility, or a user-selected set of the patient support apparatuses 20. Patient support apparatus 20 is therefore configured to not only select an appropriate brightness level automatically based on algorithms 170, 190, and/or its own onboard linear regression analysis, but it is also configured to select an appropriate brightness level based on data received from an off-board server. The automatic brightness selection functions of patient support apparatus 20 can therefore be controlled and/or updated from one or more remote servers.

In carrying out a machine learning algorithm, whether performed locally on patient support apparatus 20 or remotely on one or more servers, it will be understood that controller 126 and/or an offboard server may be modified to utilize other machine learning algorithms besides linear regression analyses. For example, in some embodiments, any one or more of the following techniques may be used by controller 126 and/or an offboard server to select an appropriate brightness level for display 52 and/or lights 56, 62, 66, 68, 118, and/or 120: artificial neural networks, decision trees, support vector machines, non-linear regression analyses, and Bayesian networks. Still further, in some embodiments, additional data may be gathered by patient support apparatus 20 for use in the selected machine learning model. Such additional data may include the room in which the patient support apparatus 20 is located, the time of day, a particular caregiver who makes a change to the brightness level, the configuration of deck 30, the particular control(s) utilized when a brightness level change is made (and not made), etc. Such additional data may be gathered and analyzed to determine what effect, if any, this additional data has on an optimal brightness level for display 52 and/or any of lights 56, 62, 66, 68, 118, and/or 120.

In addition to adjusting the brightness of display 52 and/or lights 56, 62, 66, 68, 118, and/or 120, patient support apparatus 20 may be adapted to additionally, or alternatively, automatically make color adjustments to display 52 and/or lights 56, 62, 66, 68, 118, and/or 120. Such color adjustments may be made based on the time of day, a spectral analysis of the current ambient light, and/or other factors. In some embodiments, controller 126 is adapted to automatically change a color temperature, and/or other color characteristic, of display 52 and/or lights 56, 62, 66, 68, 118, and/or 120 based on the time of day and/or based on a spectral analysis of the ambient light. In such embodiments, for example, patient support apparatus 20 may be configured to automatically reduce the amount of blue light emitted from display 52 and/or any of lights 56, 62, 66, 68, 118, and/or 120 during evening hours when such blue light may be considered to interfere with a patient's sleep patterns. In still other embodiments, patient support apparatus 20 may be configured to change the color temperature of the emitted light in a manner that gives the emitted light more or less contrast with its ambient surroundings, and/or in still other manners.

It will be understood that a variety of different modifications may be made to patient support apparatus 20. For example, in some embodiments, patient support apparatus 20 may be configured to automatically implement a fixed brightness level at certain times of the day and to automatically adjust the brightness level of display 52 and/or lights 56, 62, 66, 68, 118, and/or 120 at other times of the day. In such embodiments, manual brightness control 134 may override these automatic brightness selections. In still other modified embodiments, manual brightness control 134 may be omitted.

In at least some embodiments, patient support apparatus 20 is configured to automatically change the monitoring system 160 based on a time of day. As an example, in some embodiments, controller 126 may be configured to relax the criteria for triggering a monitoring alert during daytime hours, and to tighten the criteria during nighttime hours. For instance, controller 126 may be configured to automatically allow litter frame 28 to be moved to a non-minimum height during daytime hours without triggering a monitoring alert, but to not allow such movement during nighttime hours without triggering the monitoring alert. Still other variations are possible.

In some modified embodiments, patient support apparatus 20 is configured to automatically change a brightness level of display 52 and/or lights 56, 62, 66, 68, 118, and/or 120 based on one or more triggering conditions, such as a time of day and/or movement of patient support apparatus 20 from one location to another. In at least one such modified embodiment, controller 126 makes no other automatic adjustment to the brightness level (and indeed, patient support apparatus 20 in such modified embodiments may omit any ambient light sensors 110) based on ambient light conditions, but instead only makes such brightness changes based on one or more triggering conditions. In another of such modified embodiments, controller 126 makes automatic adjustments to the brightness levels based both on one or more triggering conditions, as well as based on the ambient light levels. Still other modifications are possible.

In those embodiments where controller 126 is configured to make automatic brightness adjustments based on movement of patient support apparatus 20, controller 126 may be configured to automatically increase the brightness level of display 52 and/or any of the other lights mentioned herein when controller 126 detects movement of the patient support apparatus 20. Such movement may be detected by the release of the brake and/or the unplugging of the AC power cord 146, and/or in combination with one or more onboard motion sensors (e.g. one or more accelerometers, wheel encoders, etc.). The automatic increase in the brightness in response to motion detection may be an increase to the maximum brightness of display 52, or it may be a lesser increase. In other embodiments, controller 126 may be configured to make different changes to the brightness of different control panels 54a-c in response to movement of the patient support apparatus 20. In still other embodiments, controller 126 may be configured to reduce the brightness level of display 52 and/or one or more lights in response to movement of patient support apparatus 20. In any of these embodiments, controller 126 is further configured to automatically rescind these automatic brightness changes when patient support apparatus 20 comes to a stop (either immediately, or after a predetermined time period).

Various additional alterations and changes beyond those already mentioned herein can be made to the above-described embodiments. This disclosure is presented for illustrative purposes and should not be interpreted as an exhaustive description of all embodiments or to limit the scope of the claims to the specific elements illustrated or described in connection with these embodiments. For example, and without limitation, any individual element(s) of the described embodiments may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Any reference to claim elements in the singular, for example, using the articles “a,” “an,” “the” or “said,” is not to be construed as limiting the element to the singular.

1. A patient support apparatus comprising:
a frame;
a support surface supported by the frame and adapted to support a patient thereon;
a display adapted to display information at multiple brightness levels;
a plurality of ambient light sensors adapted to detect ambient light levels adjacent the display; and
a controller in communication with the display and the plurality of ambient light sensors, the controller adapted to receive ambient light level readings from each of the plurality of ambient light sensors and to determine if the ambient light level readings are within a predetermined range, the controller further adapted to determine an average light level reading by averaging together only those ambient light level readings that are within the predetermined range and to use the average light level reading to automatically select a particular brightness level for the display and to cause the display to display the information at the particular brightness level.

2. The patient support apparatus of claim 1 further comprising a plurality of indicators spaced away from the display and configured to be illuminated at multiple brightness values, wherein the controller is further adapted to automatically use the average light level reading to automatically select a particular brightness value for illuminating the plurality of indicators.

3. (canceled)

4. The patient support apparatus of claim 1 further comprising a plurality of controls spaced away from the display and configured to be illuminated at multiple brightness values, wherein the controller is further adapted to automatically use the average light level reading to automatically select a particular brightness value for illuminating the plurality of controls.

5. The patient support apparatus of claim 4 wherein a first subset of the plurality of controls are positioned adjacent a right side of the display and a second subset of the plurality of controls are positioned adjacent a left side of the display.

6. The patient support apparatus of claim 1 wherein the controller is further adapted to apply a low pass filter to the ambient light level readings prior to determining if the ambient light level readings are within a predetermined range, the low pass filter adapted filter out transient changes in the ambient light level readings.

7. The patient support apparatus of claim 6 wherein the controller is further adapted to apply a compensation factor to the average light level reading and to use the compensated average light level reading to select the particular brightness level for the display, the compensation factor adapted to compensate for ultraviolet and infrared components of the ambient light level readings.

8-18. (canceled)

19. A patient support apparatus comprising:
a frame;
a support surface supported by the frame and adapted to support a patient thereon;
a display adapted to display information at multiple brightness levels;
an ambient light sensor adapted to detect ambient light levels adjacent the display; and
a controller in communication with the display and the ambient light sensor, the controller adapted to receive ambient light level readings from the ambient light sensor and to use the ambient light level readings to automatically select a particular brightness level for the display and to cause the display to display the information at the particular brightness level.

20. The patient support apparatus of claim 19 further comprising:
a set of controls spaced away from the display and configured to be illuminated at multiple brightness levels; and
a second ambient light sensor associated with the set of controls, the second ambient light sensor adapted to generate a separate ambient light level reading indicative of a level of ambient illumination adjacent the set of controls;
wherein the controller is further adapted to automatically select a specific brightness level for the set of controls based on the separate ambient light level reading and to cause the set of controls to be illuminated at the specific brightness level, wherein the specific brightness level is independent of the particular brightness level.

21. The patient support apparatus of claim 19 wherein the controller is further configured to override the particular brightness level in response to a triggering condition, wherein the controller automatically illuminates the display at a preset brightness level in response to the triggering condition.

22. The patient support apparatus of claim 21 wherein the triggering condition is movement of the patient support apparatus from one location to another location, and the preset brightness level is a maximum brightness level.

23. The patient support apparatus of claim 21 wherein the triggering condition is a particular time of day.

24. The patient support apparatus of claim 19 further comprising a manual brightness control adapted to be activated and deactivated by a user, wherein the controller is further adapted to cause the display to display the information at a user-defined brightness level when the manual brightness control is activated and to display the information at the particular brightness level when the manual brightness control is not activated.

25. The patient support apparatus of claim 24 wherein the controller is further adapted to store in a memory the user-defined brightness levels and a plurality of concomitant ambient light level readings taken when the manual brightness control has been activated, to use the stored plurality of concomitant ambient light level readings and the stored user-defined brightness levels in a machine learning algorithm, and to use the machine learning algorithm to define a future particular brightness level for the display for future use when the user has not activated the manual brightness control.

26-36. (canceled)

37. A patient support apparatus comprising:
a frame;
a support surface supported by the frame and adapted to support a patient thereon;
a display adapted to display information at multiple brightness levels;
an ambient light sensor adapted to detect ambient light levels adjacent the display;
a manual brightness control adapted to be activated and deactivated by a user, the manual brightness control adapted to cause the display to display the information at a user-defined brightness level when the manual brightness control is activated;
a controller in communication with the display, the ambient light sensor, and the manual brightness control, the controller adapted to receive ambient light level readings from the ambient light sensor and to perform the following:
(a) when the manual brightness control is not activated, to use the ambient light level readings to automatically select a particular brightness level for the display and to cause the display to display the information at the particular brightness level; and
(b) when the manual brightness control is activated, to store in a memory a plurality of the user-defined brightness levels and a plurality of concomitant ambient light level readings, and to use the stored plurality of concomitant ambient light level readings and the stored user-defined brightness levels in a machine learning algorithm, the machine learning algorithm adapted to define a future particular brightness level for the display for future use when the user has not activated the manual brightness control.

38. The patient support apparatus of claim 37 further comprising a plurality of indicators spaced away from the display and configured to be illuminated at multiple brightness values, wherein the controller is further adapted to automatically perform the following: (a) when the manual brightness control is not activated, to use the ambient light level readings to automatically select a brightness value for illuminating the plurality of indicators; and (b) when the manual brightness control is activated, to use the user-defined brightness level to illuminate the plurality of indicators.

39. The patient support apparatus of claim 38 wherein the selected brightness value is different from the particular brightness level.

40. The patient support apparatus of claim 38 wherein the plurality of indicators are included within a dashboard positioned underneath the display.

41. The patient support apparatus of claim 37 further comprising a plurality of controls spaced away from the display and configured to be illuminated at multiple brightness values, wherein the controller is further adapted to perform the following: (a) when the manual brightness control is not activated, to use the ambient light level readings to automatically select a brightness value for illuminating the plurality of controls; and (b) when the manual brightness control is activated, to use the user-defined brightness level to illuminate the plurality of controls.

42. The patient support apparatus of claim 41 wherein a first subset of the plurality of controls are positioned adjacent a right side of the display and a second subset of the plurality of controls are positioned adjacent a left side of the display.

43-51. (canceled)

52. The patient support apparatus of claim 37 further comprising a second light sensor adapted to detect second ambient light levels adjacent the display; wherein the controller is further adapted to determine if the ambient light level readings and the second ambient light levels are within a predetermined range, to determine an average light level reading by averaging together only those of the ambient light level readings and the second ambient light levels that are within the predetermined range, and to use the average light level reading to select the particular brightness level for the display when the manual brightness control is not activated.
